(19) United States
(12) Patent Application Publication
(10) Pub. No.: US 2016/0177066 A1
(43) Pub. Date: Jun. 23, 2016

(54) Manufacturing Materials from Wastewater Effluent

(71) Applicant: APPLIED CLEANTECH INC., NEW YORK, NY (US)

(72) Inventor: REFAEL AHARON, MAALLE ADUMIM (IL)

(21) Appl. No.: 14/893,868

(22) PCT Filed: May 23, 2014
(86) PCT No.: PCT/US2014/039306

§ 371 Date: Nov. 24, 2015

Related U.S. Application Data
(60) Provisional application No. 61/827,588, filed on May 25, 2013.

(51) Int. Cl. C08L 1/02

(52) U.S. Cl. CPC C08L 1/02

(57) ABSTRACT

The subject matter of the instant application relates to bioplastic compositions, nanocellulose material, nanocrystallme cellulose material, and/or nanofibers made from the cellulosic preparation that is obtained from wastewater effluent and methods and systems for producing these bioplastic compositions, nanocellulose material, nanocrystallme cellulose material, and/or nanofibers.

### CROSS-REFERENCE TO RELATED APPLICATIONS

This application claims priority to, and the benefit of U.S. Provisional Patent Application No. 61/827,588 filed May 25, 2013 and entitled “Methods and Systems for Manufacturing Bioplastics from Sewage”, the entire disclosure of which is incorporated herein by reference in its entirety.

### TECHNICAL FIELD

The present disclosure relates generally to manufacturing materials from a wastewater effluent.

### BACKGROUND

Cellulose is an organic compound defined as a polysaccharide structure of a linear chain of several hundred to over ten thousand glucose units. Fibers including cellulose can be found in sewage systems, such as municipal sewage waste systems, industrial waste systems and/or agricultural waste systems, for example. The source of cellulose fibers in the municipal sewage waste system is typically from fruits, vegetables, paper, cloths and/or laundry refuse. For example, a cellulose fiber portion of raw sewage, i.e., untreated sewage, includes generally 30-50% textile fibers, 10-35% vegetative fibers and 20-40% paper fibers.

Currently, plastics are formed mainly from petrochemical sources, which can be environmentally hazardous. There is a plastic-polyvinyl chloride (“PVC”), which is a widely-produced plastic and used in construction and other industries. Additional plastics include polyethylene, high-density polyethylene (“HDPE”), polypropylene (“PP”), and acrylonitrile butadiene styrene (“ABS”). Bioplastics are a form of plastics derived from renewable biomass sources, rather than fossil-fuel plastics which are derived from petrochemical sources. Currently, bioplastics are made from wood pulp, an environmentally controversial resource. Thus, there is a need to produce bioplastics from a high-cellulose and environmentally safe resource.

Nanocellulose is a material composed of nanosized cellulose fibrils and can include microfibrillated cellulose (“MFC”), nanofibrillated cellulose (“NFC”) and/or nanocrystalline cellulose (“NCC”). Cellulose chains are biosynthesized in cell walls, for example, and self-assembled into microfibrils, which associate to form fibrils. The cellulose microfibrils can be made up of amorphous and crystalline sections. Currently, most of the nanocellulose material is formed of wood pulp, an environmentally controversial resource. Thus, there is a need to produce nanocellulose from a high-cellulose and environmentally safe resource.

### SUMMARY

There is provided according to some embodiments of the disclosure, a method for producing a plastic composition from a wastewater effluent that includes obtaining a cellulosic preparation from the wastewater effluent, processing, using a plastic processing process, the cellulosic preparation; and producing, based on the processing, the plastic composition, where the cellulosic preparation includes a predetermined dry weight content of cellulose.

In some embodiments, obtaining a cellulosic preparation from the wastewater effluent may include removing grit from the wastewater effluent; obtaining at least one solid material from the wastewater effluent; and drying the obtained at least one solid material.

In some embodiments, the predetermined dry weight content of cellulose is 40% or more. In other words, the cellulosic preparation includes at least 40% weight content of cellulose.

In some embodiments, the predetermined dry weight content of cellulose is 60% or more. In other words, the cellulosic preparation includes at least 60% weight content of cellulose.

In some embodiments, the plastic processing process includes at least one of the following: an extrusion molding, an injection molding, and a blow molding.

In some embodiments, processing the cellulosic preparation includes mixing the cellulosic preparation with at least one additional plastic material. For example, the additional plastic material may include at least one of the following: polyethylene, polypropylene and acrylonitrile butadiene styrene, polyvinyl chloride, polycarbonate and a thermoplastic and a combination thereof. For example, the additional plastic material includes a petrochemical containing plastic.

In some embodiments, the cellulosic preparation includes a filler when mixed with at least one additional plastic material. For example, the filler is 1-50% of total dry weight of the plastic composition.

In some embodiments, the cellulosic preparation includes a plasticizer when mixed with at least one additional plastic material. For example, the plasticizer is 1-10% of total dry weight of the plastic composition.

In some embodiments, the cellulosic preparation includes a dry weight content of lignin in a range of 0-15%.

In some embodiments, the cellulosic preparation includes a dry weight content of oil in a range of 0-30%.

In some embodiments, the cellulosic preparation is not produced by biological processes.

In some embodiments, the cellulosic preparation is not produced by chemical processes.

In some embodiments, the wastewater effluent is obtained from at least one of the following: a wastewater treatment plant, a municipal sewage wastewater system, an agricultural wastewater system, an industrial wastewater system, a pulp and/or paper industry wastewater system, a paper plant and a paper mill.

In some embodiments, obtaining a cellulosic preparation from the wastewater effluent includes controlling the cellulosic preparation at a predetermined dryness degree and/or a predetermined particle size. For example, obtaining a cellulosic preparation from the wastewater effluent includes measuring the predetermined dryness degree using at least one sensor. For example, obtaining a cellulosic preparation from the wastewater effluent includes measuring the predetermined particle size using at least one sensor.

In some embodiments, the cellulosic preparation is characterized by a predetermined dryness degree. For example, the predetermined dryness degree is in the range of 70%-99.99%.

In some embodiments, the cellulosic preparation is characterized by a predetermined particle size. For example, the predetermined particle size of the cellulosic preparation is in the range of 0.01 μm-500 mm.

There is also provided according to some embodiments of the disclosure, a method for producing a nanocellulose composition from a wastewater effluent by obtaining a cellulosic preparation from the wastewater effluent; removing at least one non-cellulosic material from the cellulosic preparation; degrading the obtained cellulosic preparation; and producing the nanocellulose composition, where the cellulosic preparation includes a predetermined dry weight content of cellulose.

In some embodiments, the wastewater effluent includes at least one of the following: a wastewater from a pulp and a wastewater from a paper mill.

In some embodiments, obtaining a cellulosic preparation from the wastewater effluent may include removing grit from the wastewater effluent; and obtaining at least one solid material from the wastewater effluent.

In some embodiments, the predetermined dry weight content of cellulose is 70% or more. In other words, the cellulosic preparation includes at least 70% weight content of cellulose.

In some embodiments, the degrading is performed by a delamination device, where the delamination device includes at least one of the following: a high-pressure impact homogenization device, a high temperature impact homogenization device, a high velocity impact homogenization device, and a sonication device.

In some embodiments, the degrading is performed by hydrolysis.

In some embodiments, the degrading is performed by acid hydrolysis. For example, the acid hydrolysis is performed with a sulfuric acid, or hydrochloric acid or a combination thereof.

In some embodiments, the wastewater effluent is from any one of: a wastewater treatment plant, a municipal sewage wastewater system, an agricultural wastewater system, an industrial wastewater system, a pulp and/or paper industry wastewater system, a paper plant and a paper mill.

In some embodiments, the nanocellulose composition includes a nanofibrillated cellulose material.

In some embodiments, the nanocellulose composition includes a nanocrystalline cellulose material.

In some embodiments, the cellulosic preparation is characterized by a predetermined dryness degree. For example, the predetermined dryness degree is in a range of 70%-99.99%.

In some embodiments, the cellulosic preparation is characterized by a predetermined particle size. For example, the predetermined particle size of the cellulosic preparation is in a range of 0.01 μm-500 mm.

In some embodiments, the nanocellulose composition is characterized with a lateral dimension in the range of 1-100 nanometers and a longitudinal dimension in the range of 10-9000 nanometers.

In some embodiments, the nanocellulose composition is characterized with a lateral dimension in the range of 1-100 nanometers and a longitudinal dimension in the range of 100-1000 nanometers.

Further provided is a system for producing a bioplastic composition from a wastewater effluent that includes at least one of the following: a pretreatment device for pre-treating the wastewater effluent; a grit removal device for removing grid from the wastewater effluent; a solid collection device for collecting at least one solid material from the wastewater effluent; a drying device for drying at least a portion of the wastewater effluent; a shaping device for shaping at least a portion of the dried solid portion; and a plastic processer for producing the bioplastic composition using at least one material produced as a result of at least one operation performed on the wastewater effluent by the at least one of the pretreatment device, the grit removal device, the solid collection device, the drying device, and the shaping device.

In some embodiments, the system may also include a mixer.

Also provided is a plastic composition that includes a filler and a plastic material.

In some embodiments, the filler is a cellulosic preparation obtained from a wastewater effluent and having a predetermined dry weight content of cellulose.

In some embodiments, the cellulosic preparation is 1-99% (by dry weight) of the plastic composition.

In some embodiments, the predetermined dry weight content of cellulose is greater than or equal to 40%.

In some embodiments, the predetermined dry weight content of cellulose is greater than or equal to 60%.

In some embodiments, the plastic composition has a form that includes at least one of the following: a sheet, a rod, a board, a container, and a pipe.

In some embodiments, the plastic material includes at least one of the following: a polyethylene, a polypropylene and acrylonitrile butadiene styrene, a polyvinyl chloride, a polycarbonate and a thermoplastic and any combination thereof.

There is also provided according to an embodiment of the disclosure, a nanocellulose composition made according to the method described herein.

In some embodiments, the nanocellulose composition includes at least one of the following: a microfibrillated cellulose (MFC), a nanofibrillated cellulose (NFC), and a nanocrystalline cellulose (NCC).

In some embodiments, the nanocellulose composition is characterized with a lateral dimension in the range of 1-100 nanometers and a longitudinal dimension in the range of 10-9000 nanometers.

In some embodiments, the nanocellulose composition is characterized with a lateral dimension in the range of 1-100 nanometers and a longitudinal dimension in the range of 100-1000 nanometers.

There is also provided according to an embodiment of the disclosure, a bioplastic composition made according to the method described herein.

There is also provided according to an embodiment of the disclosure, a plastic material made according to the method described herein.

There is also provided according to an embodiment of the disclosure, a nanocellulose material made according to the method described herein.

In some embodiments, the nanocellulose material is characterized with a lateral dimension in the range of 1-100 nanometers and a longitudinal dimension in the range of 10-9000 nanometers.

In some embodiments, the nanocellulose material is characterized with a lateral dimension in the range of 1-100 nanometers and a longitudinal dimension in the range of 100-1000 nanometers.

There is also provided according to an embodiment of the disclosure, a nanocrystalline cellulose material made according to the method described herein.

There is also provided according to an embodiment of the disclosure, a nanofiber material made according to the method described herein.

In some implementations, the current subject matter can be operated using and/or implement various computer-implemented methods, devices, systems, and/or computer program products. Such, non-transitory computer program products (i.e., physically embodied computer program products) can store instructions, which when executed by one or more data processors of one or more computing systems, causes at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including but not limited to a connection over a network (e.g., the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations.

FIG. 1 is a schematic illustration of an exemplary system for producing bioplastic materials from wastewater effluent, according to some embodiments of the current subject matter;

FIG. 2 is a schematic illustration of an exemplary system for producing bioplastic materials from wastewater effluent, according to some embodiments of the current subject matter;

FIG. 3 is an exemplary graph showing the modulus of elasticity of some of the bioplastic materials processed in the system shown in FIG. 2;

FIG. 4 is a schematic illustration of an exemplary system for producing nanocellulose materials from wastewater effluent, according to some embodiments of the current subject matter; and

FIG. 5 is a schematic illustration of an exemplary system for producing nanocellulose materials from wastewater effluent, according to some embodiments of the current subject matter.

FIG. 6 is an exemplary flowchart of a process for producing bioplastic materials from wastewater effluent, according to some embodiments of the current subject matter;

FIG. 7 is an exemplary flowchart of a process for producing bioplastic materials from wastewater effluent, according to some embodiments of the current subject matter;

FIG. 8 is an exemplary flowchart of a process for producing nanocellulose materials from wastewater effluent, according to some embodiments of the current subject matter;

FIG. 9 is an exemplary flowchart of a process for producing nanocellulose materials from wastewater effluent, according to some embodiments of the current subject matter;

FIG. 10 illustrates an exemplary system, according to some embodiments of the current subject matter;

FIG. 11 illustrates an exemplary method, according to some embodiments of the current subject matter; and

FIG. 12 illustrates another exemplary method, according to some embodiments of the current subject matter.

### DETAILED DESCRIPTION

In the following description, various aspects of the current subject matter are disclosed. For purposes of explanation, specific configurations and details are set forth in order to provide a thorough understanding of the current subject matter. However, it will also be apparent to one skilled in the art that the current subject matter can be practiced without the specific details presented herein. Furthermore, well known features can be omitted or simplified in order not to obscure the current subject matter.

Described herein are methods for producing a plastic composition from a wastewater effluent that includes obtaining a cellulosic preparation from the wastewater effluent, processing, using a plastic processing process, the cellulosic preparation; and producing, based on the processing, the plastic composition, where the cellulosic preparation includes a predetermined dry weight content of cellulose.

Also provided herein are methods for producing a nanocellulose composition from a wastewater effluent by obtaining a cellulosic preparation from the wastewater effluent; removing at least one non-cellulosic material from the cellulosic preparation; degrading the obtained cellulosic preparation; and producing the nanocellulose composition, where the cellulosic preparation includes a predetermined dry weight content of cellulose.

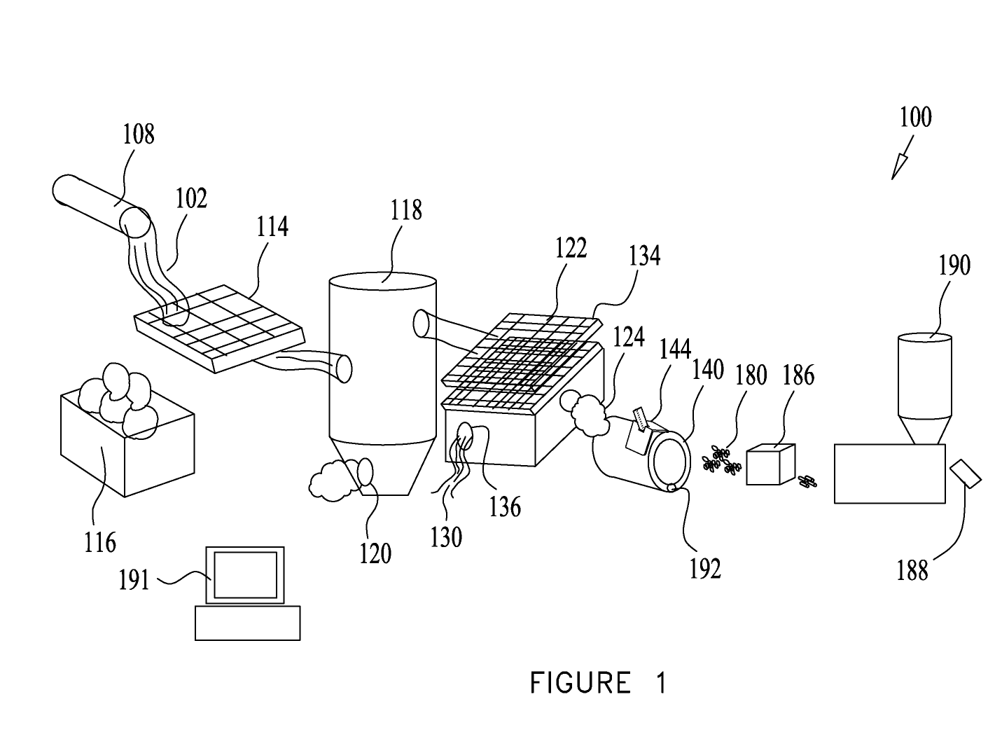

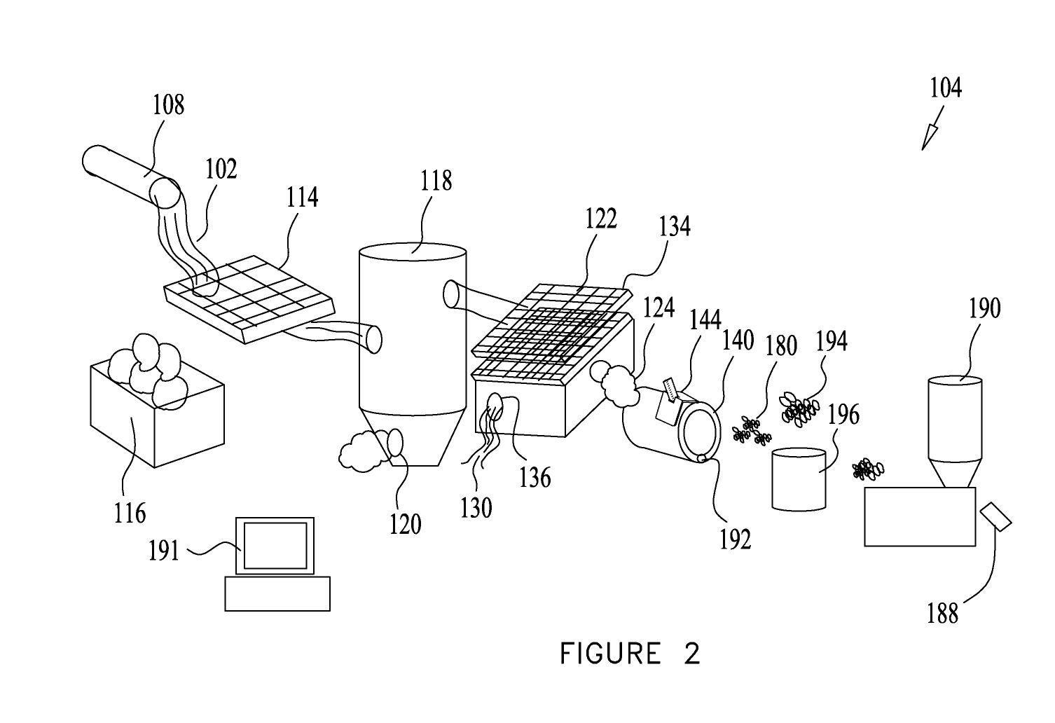

Reference is now made to FIG. 1, which is a schematic illustration of an exemplary system 100 for producing bioplastic materials from wastewater effluent 102, and to FIG. 2, which is a schematic illustration of an exemplary system 104 for producing bioplastic materials from wastewater effluent 102.

The system 100 (shown in FIG. 1) for producing bioplastic materials from wastewater effluent can include at least some of the following: a pretreatment device 114, a grit removal device 118, a solid collection device 122, a drying device 140, a shaping device 186, and/or a plastic processor 190.

The system 104 (shown in FIG. 2) for producing bioplastic materials from wastewater effluent can include the devices of the system 100 and in some embodiments can also include at least some of the following: a pretreatment device 114, a grit removal device 118, a solid collection device 122, a drying device 140, a mixer 196 and/or a plastic processor 190.

In some embodiments, the wastewater effluent 102 can include raw sewage. Raw sewage can be defined as sewage flowing within a sewerage waste system prior to standard wastewater treatment thereof. Standard wastewater treatment can include sedimentation, aeration and/or digestion of the wastewater. The sewage wastewater system can include a wastewater treatment plant (“WWTP”).

In some embodiments, the WWTP can include a municipal sewage wastewater system, an industrial wastewater system and/or an agricultural wastewater system or any other sewage wastewater system. In some embodiments, industrial wastewater systems can include pulp and/or paper industry wastewater systems, such as wastewater flowing from paper plants or paper mills.

In some embodiments, raw sewage of the wastewater effluent in the WWTP can include a suspension including a liquid portion in a range of approximately 25-99.99% and a solid portion in a range of approximately 0.01-75% thereof. In some embodiments, such as in some WWTPs, the raw sewage includes a liquid portion of over 90%. In some embodiments, such as in some WWTPs the raw sewage includes a liquid portion of over 70%. In some embodiments, such as in some WWTPs the raw sewage includes a liquid portion of over 50%.

In some embodiments, the solid portion can be partially suspended within the liquid portion and partially solved therein. In raw sewage the solid portion can include a 50% soluble solid portion and a 50% suspended solid portion. The liquid portion can include water, soluble organic matter, minerals, oils and/or other materials. The suspended solid portion of raw sewage can include particles. The particles can include a homogenous portion and/or a heterogeneous portion of the solid portion of the sewage. Exemplary particles can contain a cellulose (i.e. fiber) content of 20-90% thereof; a hemicellulose content of 0-35% thereof; a lignin content of 0-20% thereof a nitrogen containing organic compound content of 0-20% thereof a protein containing organic compound content of 0-20% thereof a mineral content of 0-15% thereof a sand content of 0-15% thereof and a dirt content of 0-30% thereof and other sewage refuse. The solid portion can also include oil and water adsorbed to the particles. In certain aspects of the raw sewage, the solid portion of raw sewage can include 0-15% of oil therein. The portion percentages of the particles can be measured as the dry weight of the solid portion.

In some embodiments, the term “oil” can include oleaginous matter such as grease, fats and/or oils.

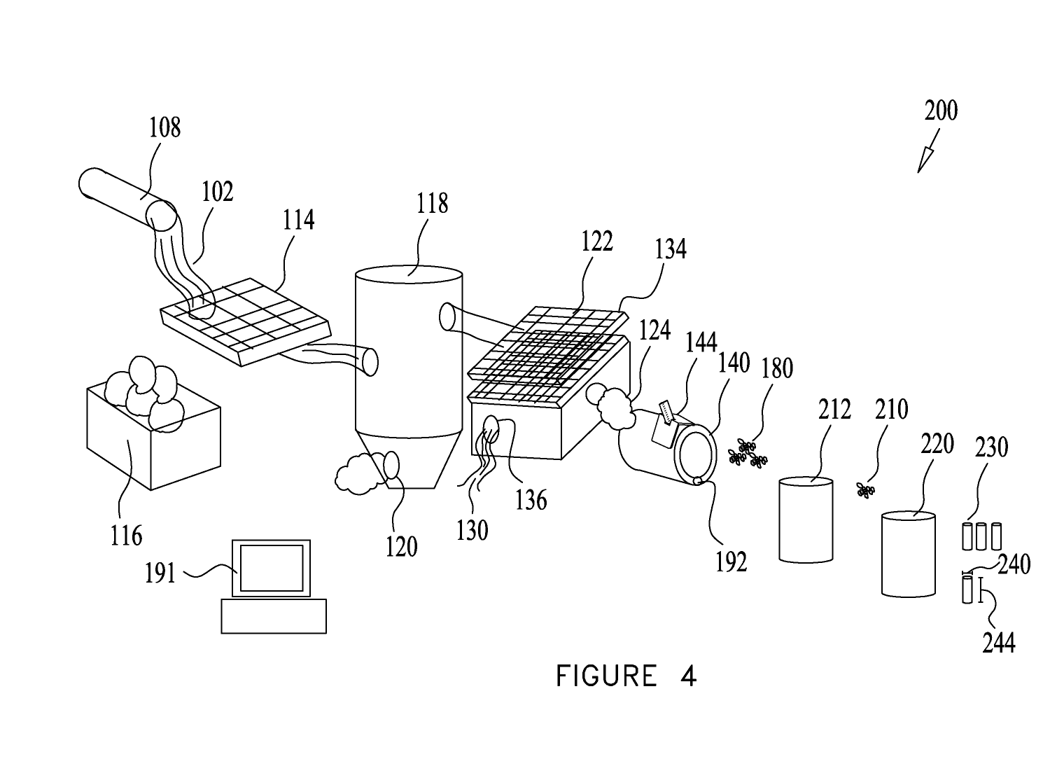

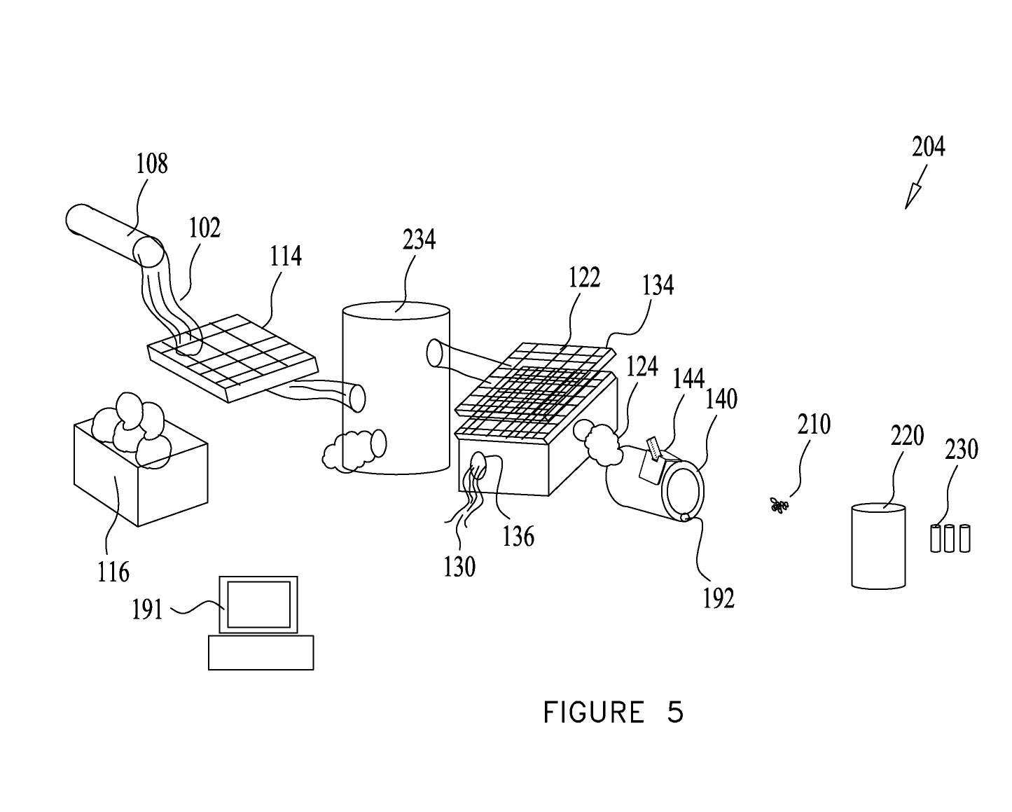

In some embodiments, the wastewater effluent 102 entering the system 100 (and/or system 104 of FIG. 2, and/or system 200 of FIG. 4 and/or system 204 of FIG. 5) can be treated sewage, typically treated by a standard wastewater treatment process, such as sedimentation, or aeration or any other process, though the sewage may not be treated by digestion, which digests the sewage into sludge.

The raw or treated wastewater effluent 102 can be effused into the system 100 (or systems 104, 200 and/or 204) from a main pipeline 108 at the entrance of a sewage waste system, a WWTP or any location within the WWTP, prior to digestion of the wastewater therein.

Initially, the wastewater effluent 102 (which can include raw sewage or treated sewage prior to digestion thereof) can be introduced into a pretreatment device 114 for removing crude, large, insoluble dirt, such as large rocks and/or plastic chunks, for example. Exemplary crude, large, dirt can have a diameter larger than 5-7 millimeters. The pretreatment device 114 can include any suitable device, such as a screen, a step screen, a sifter, and/or a filter, for example. The crude, large dirt can be removed from the system 100 is any suitable manner, such as by disposal of the crude, large dirt into a container 116. The crude, large dirt can be removed from the system 100 so as to prevent it from clogging the devices of the system 100 and flow of the wastewater effluent 102 therethrough.

The system 100 can include a grit removal device 118 configured in any suitable manner for removing grit from the wastewater. The grit can include undesired particles in the wastewater effluent, such as sand and dirt, iron, steel, dust, metals, rocks, pebbles, plastic particles and/or minerals, such as ash.

The grit removal device 118 can include any means for removing the undesired particles, such as by sedimentation performed by centrifugation, such as hydrocyclonic centrifugation, vibration or ultrasonic sedimentation and/or by screens or filters. The grit can be discarded by any suitable means, such as via an outlet 120 for directing the grit out of the system 100.

In some embodiments, the pretreatment device 114 and/or the grit removal device 118 can be configured to remove particles with or greater than a predetermined specific gravity.

In some embodiments, the undesired particle can include particles with a specific gravity higher than approximately 2 grams per milliliter. Such an undesired particle can be sand or pebbles, which have a specific gravity of 3 grams per milliliter or metal which has a specific gravity of 7 grams per milliliter.

In some embodiments, lighter dirt components, such as, but not limited to dust, can be removed by sedimentation in the grit removal device 118, or by suspending the grit components and thereafter discarding the grit suspension from the grit removal device 118. Components of grit that can be considered heavier, including, but not limited to metals, can be removed by sedimentation.

The desired particles of the wastewater, which are further processed in the system 100 or system 104 and include solid particles of a solid portion 124, can include particles with a specific gravity less than approximately 2 grams per milliliter. In some embodiments the desired particles can include particles with a specific gravity of approximately 1 gram per milliliter or less, including soluble and insoluble solids.

In some embodiments, the solid particles of the solid portion 124 exceed a size of approximately 0.01 μm. In some embodiments, the solid particles of the solid portion exceed a size of approximately 80 μm. In some embodiments, the solid particles of the solid portion 124 exceed a size of approximately 100 μm. In some embodiments, the solid particles of the solid portion 124 exceed a size of approximately 300 μm.

It is noted that the term “size” described throughout the disclosure can include any applicable parameter, such as a particle length or a particle diameter, for example.

The now grit-removed, cleaned wastewater effluent 102 can flow to a solid collection device 122 configured in any suitable manner for collecting a solid portion 124 from the cleaned wastewater effluent 102, thereby substantially separating the solid portion from a liquid portion 130.

In some embodiments, the solid portion 124 can include solid particles and liquids adsorbed to the solid particles, such as oils and/or water.

In some embodiments, the solid collection device 122 can include a single net 134 or a multiplicity of nettings for collecting the solid portion 124 from the wastewater effluent 102. The multiplicity of nettings can be a series of nettings where each subsequent netting can be formed with apertures of a smaller size than the previous netting to provide additional collection of solid particles from the wastewater effluent 102. The mesh size of the netting 134 is designed to collect a desired size of the solids. In some embodiments, the netting 134 can be formed with a mesh size configured to collect solids with an average diameter of 0.01 nm −100 mm or 0.1 nm −500 mm.

The netting 134 can be formed in any suitable configuration for collecting the solid portion 124 and can be formed of any suitable material for flow of the wastewater effluent 102 therethrough, such as a corrosive resistive material and/or a high pressure resistive material, typically aluminum, for example.

The solid collection can be achieved in any suitable manner, such as by collection with conveyor belts formed of conveyor belt mesh, centrifugation, such as flow centrifugation or a hydrocyclone, for example, collection by screw presses, separation by use of vibration in a vibration separator, filtering by disk filters, filter presses, media filters, such as filters containing fibers, for example, biological filters, such as filters containing cellulose, for example, chemical filters, such as filters containing silica, for example, a filter employing backflushing technology, or any other suitable manner for entrapping solids from the wastewater effluent.

A backflushing filter can include a screen or a filtration media operative to filter solids such that solids accumulate on a first surface of the screen or filtration media. Liquid is urged to flow from an opposite surface of the screen or filtration media to the first surface thereof. This reverse flow of liquid through the screen or filtration media is used for removing solids accumulated on the screen or filtration media during the filtration process. In some embodiments, the liquid used in a backflushing filter can include, but is not limited to, water.

The residual, liquid portion 130 can be discharged from solid collection device 122 via an outlet 136 or any suitable means. The liquid portion 130 can include the liquid portion of the wastewater effluent 102 and can additionally include relatively small solid particles, typically particles with a size of less than approximately 0.01-80 μm. In some embodiments, the liquid portion 130 can be discarded or can flow to a wastewater management system, such as back to the WWTP in any suitable manner, e.g. by conduits.

In some embodiments, the liquid portion 130 is approximately 80-95% of the raw sewage entering the system 100 and/or system 104. The remaining portion, typically 5-20% of the wastewater effluent 102, is the collected solid portion 124.

In some embodiments, the collected solid portion 124 can be dried to a predetermined dryness degree thereof.

The drying can be performed by a drying device 140 configured to achieve the predetermined humidity level of the collected solid portion 124. In some embodiments the drying device 140 can utilize heat, pressure or any other suitable means to achieve the predetermined dryness degree of the collected solid portion 124. In some embodiments, the drying device 140 can include a heater, such as radiators, ovens or furnaces, heat exchangers, heat treatment, such as solar heat, placing the solid portion in a greenhouse and/or blowers for blowing a hot fluid over or through the solid portion. In some embodiments, the drying device 140 can dry the collected solid portion 124 by a cryogenic treatment, vacuum, a press, such as a screw press, a drum dryer, or a combination thereof.

In some embodiments, the drying can be performed by more than one device or processes, such as by initial removal of the liquid from the collected solid portion 124 by applying mechanical pressure thereon, such as by a press, for example. Thereafter, heat can be applied by a heater for further drying to a predetermined dryness degree thereof.

In a non-limiting example, the dryness degree of the collected solid portion 124 prior to being dried in the drying device 140 can include a dryness degree in the range of approximately 5%-50%. In a non-limiting example, the drying device 140 can be configured to dry the collected solid portion 124 to a predetermined dryness degree in the range of approximately 70%-99.99%. In a non-limiting example, the predetermined dryness degree is the range of approximately 85%-99.99%. In a non-limiting example, the predetermined dryness degree is the range of approximately 90%-99.99%. In a non-limiting example, the predetermined dryness degree is the range of approximately 92%-99%.99. In a non-limiting example, the predetermined dryness degree is the range of approximately 95%-99.99%. In a non-limiting example, the predetermined dryness degree is 99% or more.

In a non-limiting example, the predetermined particle size of the cellulosic preparation 180 can be any size in the range of 0.01 μm-500 mm.

In some embodiments, the collected solid portion 124 can be cleaved or grinded for reducing the size of relatively large solids, such as branches, cloths or moist towelettes, for example. In a non-limiting example these large solids can include a size large than 1 cm.

In some embodiments, the collected solid portion 124 can be de-clumped to separate particles of the solid portion, which can tend to agglomerate. The tendency to agglomerate can be augmented due to a relatively high oleaginous content of the solid portion. In a non-limiting example, the oleaginous content of the solid portion can be 15% or less. In a non-limiting example, the oleaginous content of the solid portion can be 30% or less.

De-clumping the agglomerates of the solid portion and/or possible cleaving of the fibers increases a surface area of the particles of the solid portion.

In some embodiments, the collected solid portion 124 can be stirred. Stirring, de-clumping and/or cleaving the collected solid portion 124 can increase the homogeneity thereof, therefore resulting in a superior cellulosic preparation.

In some embodiments, the cleaving, de-clumping, grinding and/or stirring can be performed by a grinding device configured to cleave, de-clump, grind and/or stir. In some embodiments, the cleaving, de-clumping, grinding and/or stirring can be performed by a pressure device, such as a pump or a water jet. In some embodiments, the drying device 140 can include paddles 144 or any other means to cleave, de-clump, grind and/or stir the collected solid portion 124.

In some embodiments, the grinding can be controllably performed to achieve a predetermined particle size.

In some embodiments, iron and/or steel or any metal can be removed by any suitable means, such as by utilizing a magnet which attracts the metal thereto thus removing a portion of the metal from the sewage. The magnet may be placed after the drying device 140 or any other suitable location within the system 100.

The collected solid portion dried to the predetermined dryness degree includes a cellulosic preparation 180.

The cellulosic preparation 180 produced from the wastewater effluent 102 can include a high cellulosic content. In a non-limiting example, a cellulosic preparation produced from corn contains a 37.4% cellulosic portion of the dry weight, while relatively high cellulose content in the cellulosic preparation 180 produced from the wastewater effluent 102 by the systems and methods of the disclosure is at least 40% of the dry weight or more. In some embodiments, the cellulose content in the cellulosic preparation 180 is at least 50% of the dry weight or more. In some embodiments, the cellulose content in the cellulosic preparation 180 is at least 60% of the dry weight or more. In some embodiments, the cellulose content in the cellulosic preparation 180 is at least 70% of the dry weight or more. In some embodiments, the cellulose content in the cellulosic preparation 180 is at least 80% of the dry weight or more. In some embodiments, the cellulose content in the cellulosic preparation 180 is at least 90% of the dry weight or more. In some embodiments, the cellulose content in the cellulosic preparation 180 is at least 95% of the dry weight or more. In some embodiments, the cellulose content in the cellulosic preparation 180 is a predetermined dry weight content thereof.

In a non-limiting example, the cellulosic preparation 180 can include a composition including, consisting essentially of, or consisting of an oil content of 0%-30% thereof; a cellulose content of 40-99% thereof; a hemicellulose content of 2-20% thereof; a lignin content of 0-15% thereof; a nitrogen containing organic compound content of 0-20% thereof; a protein containing organic compound content of 0-20% thereof; a mineral content of 0-5% thereof; a sand content of 0-5% thereof and a dirt content of 0-25% thereof.

In a non-limiting example, the cellulosic preparation 180 can include, consist essentially of or consist of particles with a size of 0.01 μm-500 mm.

In a non-limiting example, the caloric value of the cellulosic preparation 180 can be in the range of 5000-16000 British Thermal Units (“BTU”)/Pound.

In some embodiments, the cellulosic preparation 180 exiting drying device 140 includes a granular consistency. The cellulosic preparation 180 can be shaped or packaged for ease of manufacture in a shaping device 186. In a non-limiting example, the cellulosic preparation 180 can be pelletized in the shaping device 186 including a pellet machine to form pellets.

In some embodiments, the cellulosic preparation 180 can be grinded in the shaping device 186 including a grinder. The grinded cellulosic preparation 180 can be used as grinded particles. In some embodiments the grinded particles can be further heated and can have liquids added thereto, such as to form a resin, for example or to form other mixture.

In some embodiments, the cellulosic preparation 180 can be pressed by the shaping device 186 including a press machine to form other formations, such as granules, beads, cubes, or any other form with a desired shape or diameter.

In some embodiments, during formation of the cellulosic preparation pellets or other formations, some oil from the cellulosic preparation can squeeze out and coat the pellet or other formations. The oil coated cellulosic preparation pellet or other formations prevents water adsorption thereto, thereby maintaining the dryness of the cellulosic preparation.

The cellulosic preparation 180 can be used to form a bioplastic material 188.

It is noted the terms “bioplastic material” and “plastic material” can interchangeable.

In some embodiments, as shown for example in FIG. 1, the cellulosic preparation 180 can be subjected to a plastic processing process within the plastic processor 190. The plastic processing process can include any suitable process to form the bioplastic material 188. In a non-limiting example, the plastic processing process can include extrusion molding wherein the cellulosic preparation 180 can be heated and forced continuously through a forming die made in a desired shape. The formed bioplastic material 188 can be cooled by blown air or in a water bath and thereafter can be further hardened, such as on a moving belt.

In a non-limiting example, the cellulosic preparation 180 can be formed into bioplastic fibers. The bioplastic fibers can be formed by extrusion wherein the cellulosic preparation 180 is initially formed as a liquid resin and thereafter squeezed through spinnerets to produce the bioplastic fibers, which can be further woven into bioplastic fabrics.

In a non-limiting example, the plastic processing process can include injection molding wherein the cellulosic preparation 180 is heated to a semifluid state and is thereafter ejected into a mold under great pressure for quick hardening thereof. The mold is then opened and a bioplastic material 188 is released.

In a non-limiting example, the plastic processing process can include blow molding wherein the cellulosic preparation 180 is heated, partially shaped to a plastic form and inserted into a mold. Air can be blown into the plastic form forcing it to expend to the shape of the mold. In some embodiments, the cellulosic preparation 180 is heated, partially shaped to a plastic form and then clamped between a die and a cover. Air can be forced between the plastic form and the cover, thereby pressing the bioplastic material 188 into the shape of the die.

In some embodiments, the plastic processing process can include a plurality of steps, such as an initial plastic processing process, e.g., extrusion and thereafter further drying and thereafter additional plastic processing, e.g., by injection.

In some embodiments, the bioplastic material 188 is formed of the cellulosic preparation 180, such as described in reference to FIG. 1, which can be used to form plastic articles, thereby replacing plastics from petrochemical sources or other plastic polymers.

In some embodiments, additional materials can be added. For example, other plastics can be added to the cellulosic preparation 180 prior to processing thereof in the plastic processor 190 or following processing thereof in the plastic processor 190. In some embodiments, a mass of a bioplastic material 188 can include at least half cellulosic preparation 180 and the remains can be additional plastics. In a non-limiting example, a bioplastic material 188 can include a mass of 80% cellulosic preparation 180 and 20% plastic from a petrochemical source.

In some embodiments, the cellulosic preparation 180 can be processed by any suitable method to form a bioplastic containing a nitrocellulose compound, and/or a bioplastic containing cellulose acetate, and/or a bioplastic containing microcellulose or nanocellulose. Further, a halogen element may be combined with the cellulosic preparation 180 to form the bioplastic material 188.

Control functionality as well as data collecting and/or processing functionality can be embodied in processors and/or electric boards or any other suitable controller 191 of the system 100. The controller 191 can control various parameters of the operation of the system 100, such as the temperature used by the drying device 140 to reach the predetermined dryness degree of the collected solid portion 124 and/or the grinding degree used to reach the predetermined particle size of the collected solid portion 124. Sensors can be placed within the system 100 and can communicate with the controller 191 for controlling the operation of the system 100. An example of a sensor is temperature and/or humidity sensor 192 placed at any suitable location within system 100. Additionally, apparatus for measuring the particle size of the collected solid portion 124 can be placed at any suitable location within system 100.

In some embodiments, additional sensors can be provided, such a flow meters for measuring the velocity of the flow of the wastewater affluent 102.

Signals generated by the sensors 192 can be transmitted to the controller 191, which can be configured to adjust the operation of the system 100 in accordance with the received signals.

These operational parameters can be manually controlled by a human operator, or automatically controlled and/or remotely controlled from a remote location.

As shown in FIG. 2, in some embodiments, the cellulosic preparation 180 can be used as a filler or extender. Fillers can be particles added to materials, such as other plastics 194.

In a non-limiting example, the filler can include 1-50% of a total dry weight of the resultant bioplastic material 188. In a non-limiting example, the filler can include 1-30% of a total dry weight of the resultant bioplastic material 188. In a non-limiting example, the filler can include 1-20% of a total dry weight of the resultant bioplastic material 188. In a non-limiting example, the filler can include 1-8% a total dry weight of the resultant bioplastic material 188.

The additional plastics 194 can include petrochemical containing plastics, fossil fuel based plastic or virgin, recycled plastics or non-recycled plastics. In a non-limiting example the additional plastics 194 can be PVC. Additional plastics 194 can be added such as polycarbonate, for example, and other standard plasticizers and heat stabilizers.

In another non-limiting example, the additional plastics 194 can be polyethylene, polypropylene and acrylonitrile butadiene styrene, polyvinyl chloride, and/or a mixture thereof. Additional plastics can be added such as polycarbonate, for example and other plasticizers and/or heat stabilizers. In another non-limiting example, the additional plastics 194 can be any suitable thermoplastic.

In some embodiments, the cellulosic preparation 180 can initially be mixed with the additional plastics 194 in a mixer 196.

The additional plastics 194 can be provided in any suitable form, such as in a powder form, pellets, granules, beads, resin or liquid, for example.

The combined cellulosic preparation 180 and additional plastic 194 can be processed in the plastic processor 190 to form a bioplastic material 188.

Examples 1-4 below illustrate various uses of the cellulosic preparation 180 as a filler combined with additional plastics 194.

In some embodiments, the cellulosic preparation 180 can be contacted with plasticizers (e.g. phthalate esters which can be used as plasticizers for PVC) as well as the additional plastics 194.

Plasticizers are additives that increase the plasticity, fluidity and/or rheology of a material. Plasticizers work by embedding themselves between the chains of polymers, spacing them apart, and thus significantly lowering the glass transition temperature for the plastic and making it softer.

In some embodiments, the cellulosic preparation 180 can be used as a plasticizer and blended with other materials, such as additional plastics 194 or even other types of materials, such as clay, concrete and/or cement. In some embodiments, a relatively small mass of cellulosic preparation 180 is sufficient to blend with an additional plastic 194 for improving the plasticity, fluidity and/or rheology of the resultant bioplastic material 188. In a non-limiting example, the cellulosic preparation 180 mass can be in the range of 1-10% of the total mass of the resultant bioplastic material 188 or even as small as in a range of 1-2% of the total mass of the resultant bioplastic material 188. Plasticizers added to plastics can have an oily content so as to increase the rheology of the plastic. Accordingly, use of the cellulosic preparation 180, which can have an oil content of up to 15%, can be a superior plasticizer.

Plasticizers can be added in any suitable manner, for example, by mixing the plasticizers with plastics at room temperature. Heat can be used such as by preheating the plastics and then mixing with the plasticizers, and/or by first mixing the plasticizers and plastics at room temperature and heating the mixture thereafter.

In some embodiments, agents, such as coupling agents can be added to form the bioplastic material 188, as described in FIG. 1 or along with the filler of FIG. 2.

In the embodiments shown in FIGS. 1 and 2, the systems 100 and 104 can be configured in any suitable manner, including any suitable components operating in any suitable order or sequence. In a non-limiting example, the grit removal can be performed after the solid collection, for example. In some embodiments, one or more elements of the systems 100/104 can be omitted, for example, wherein the wastewater effluent 102 includes a very low content of grit, such as less than 5% of the solid portion thereof, grit removal can be omitted.

In some embodiments, components of the system 100 can include components of the system described in the co-owned PCT publication WO2014/057348. For example, the drying device 140 can include the drying device described in co-owned PCT publication WO2014/057348, which disclosure is incorporated herein by reference in its entirety.

In some embodiments, the cellulosic preparation 180 can be subjected to any process for producing the bioplastic material 188 therefrom.

Also provided herein is a system for producing a bioplastic composition from a wastewater effluent that includes at least one of the following: a pretreatment device for pre-treating the wastewater effluent; a grit removal device for removing grid from the wastewater effluent; a solid collection device for collecting at least one solid material from the wastewater effluent; a drying device for drying at least a portion of the wastewater effluent; a shaping device for shaping at least a portion of the dried solid portion; and a plastic processer for producing the bioplastic composition using at least one material produced as a result of at least one operation performed on the wastewater effluent by the at least one of the pretreatment device, the grit removal device, the solid collection device, the drying device, and the shaping device.

In some embodiments, the system may also include a mixer.

Also provided herein is a plastic composition that includes a filler and a plastic material.

In some embodiments, the filler is a cellulosic preparation obtained from a wastewater effluent and having a predetermined dry weight content of cellulose.

In some embodiments, the cellulosic preparation is 1-99% (by dry weight) of the plastic composition.

In some embodiments, the predetermined dry weight content of cellulose is greater than or equal to 40%.

In some embodiments, the predetermined dry weight content of cellulose is greater than or equal to 60%.

In some embodiments, the plastic composition has a form that includes at least one of the following: a sheet, a rod, a board, a container, and a pipe.

In some embodiments, the plastic material includes at least one of the following: a polyethylene, a polypropylene and acrylonitrile butadiene styrene, a polyvinyl chloride, a polycarbonate and a thermoplastic and any combination thereof.

There is also provided according to an embodiment of the disclosure, a nanocellulose composition made according to the method described herein.

In some embodiments, the nanocellulose composition is characterized with a lateral dimension in the range of 1-100 nanometers and a longitudinal dimension in the range of 10-9000 nanometers.

In some embodiments, the nanocellulose composition is characterized with a lateral dimension in the range of 1-100 nanometers and a longitudinal dimension in the range of 100-1000 nanometers.

In some embodiments, the nanocellulose includes at least one of the following: a microfibrillated cellulose (MFC), a nanofibrillated cellulose (NFC), and a nanocrystalline cellulose (NCC).

There is also provided according to an embodiment of the disclosure, a bioplastic composition made according to the method described herein.

There is also provided according to an embodiment of the disclosure, a plastic material made according to the method described herein.

There is also provided according to an embodiment of the disclosure, a nanocellulose material made according to the method described herein.

In some embodiments, the nanocellulose material is characterized with a lateral dimension in the range of 1-100 nanometers and a longitudinal dimension in the range of 10-9000 nanometers.

In some embodiments, the nanocellulose material is characterized with a lateral dimension in the range of 1-100 nanometers and a longitudinal dimension in the range of 100-1000 nanometers.

There is also provided according to an embodiment of the disclosure, a nanocrystalline cellulose material made according to the method described herein.

There is also provided according to an embodiment of the disclosure, a nanofiber material made according to the method described herein.

The following examples describe use of the cellulosic preparation 180 as a filler combined with additional plastics 194. The examples set forth are meant to exemplify various aspects in carrying out the current subject matter and are not intended to limit the current subject matter in anyway.

### Example 1

100 m³ of wastewater effluent, including a solid portion of approximately 0.1% of the wastewater effluent flowed from a municipal WWTP to the system for producing bioplastic materials from wastewater effluent. The composition of the wastewater effluent solid portion generally included 6.5% oil, 31% cellulose, 10% hemicellulose, 6% lignin, and grit including: 15.1% minerals, 15.5% sand and 15.9% dirt. Following initial pretreatment removing crude dirt, the wastewater effluent was introduced into a hydrocyclone centrifuge at a pressure of 3 atmosphere for grit removal from the wastewater effluent.

Thereafter, the wastewater effluent was introduced into a collection device formed of a net of a 250 micron mesh. Approximately 50 Kg of solids were collected within the net. The residual liquid portion was discarded.

The solid portion was pressed in a screw press for partial removal of liquids therefrom.

The resultant cellulosic preparation was thereafter dried in a drum dryer wherein most of the liquids were dried and the cellulosic preparation included a relative humidity (“RH”) degree of 1.5%.

The resultant cellulosic preparation composition generally included 13% oil, 60% cellulose, 10% hemicellulose, 6% lignin, and grit including: 5% minerals, 5% sand and 1% dirt.

The dried cellulosic preparation was pelletized in a pellet machine.

The cellulosic preparation pellets were introduced into a PVC powder mixture containing additional standard plasticizers forming a mixture containing 10% cellulosic preparation and 90% PVC powder mixture.

The mixture was extruded in conical counter rotating extruder at a temperature of 170 C.° and thereafter was pressed to form boards.

The composition of the resultant boards was substantially similar to the composition of a standard PVC board. Thus, it can be seen that the addition of the cellulosic preparation did not compromise the board quality. The surface of the boards was homogenous indicating the cellulosic preparation properly mixed with the PVC mixture.

### Example 2

100 m³ of wastewater effluent, including a solid portion of approximately 0.1% of the wastewater effluent flowed from a municipal WWTP to the system for producing bioplastic materials from wastewater effluent. The composition of the wastewater effluent solid portion generally included 6.5% oil, 31% cellulose, 10% hemicellulose, 6% lignin, and grit including: 15.1% minerals, 15.5% sand and 15.9% dirt.

Following initial pretreatment removing crude dirt, the wastewater effluent was introduced into a hydrocyclone centrifuge at a pressure of 3 atmospheres for grit removal from the wastewater effluent.

Thereafter, the wastewater effluent was introduced into a collection device formed of a net of a 250 micron mesh. Approximately 50 Kg of solids were collected within the net. The residual liquid portion was discarded.

The solid portion was pressed in a screw press for partial removal of liquids therefrom.

The resultant cellulosic preparation was thereafter dried in a vacuum dryer at a temperature of 40° C. for 12 hours wherein most of the liquids were dried and the cellulosic preparation included an RH degree of 1%.

The resultant cellulosic preparation composition generally included 13% oil, 60% cellulose, 10% hemicellulose, 6% lignin, and grit including: 5% minerals, 5% sand and 1% dirt.

The dried cellulosic preparation was grinded into powder.

The cellulosic preparation powder was introduced into a HDPE mixture containing Formdene HP4401 and hand mixed for forming a mixture containing 15% cellulosic preparation and 82% HDPE mixture and 3% of a coupling agent containing BONDYRAM® (functional polymers).

The mixture was extruded in a twin screw extruder (diameter of 25 mm) at 250 rpm.

Thereafter the mixture was vacuum dried for 12 hours at a temperature of 80° C.

75 gram of the dried mixture was subjected to injection molding at a temperature of 33° C., speed of 46 mm/sec and an initial pressure of 145 bar and a secondary pressure of 70 bar. The mixture was injected for 10 seconds and cooled for 25 seconds. Resultant specimens (i.e. bioplastic materials) were formed.

### Example 3

100 m³ of wastewater effluent, including a solid portion of approximately 0.1% of the wastewater effluent flowed from a municipal WWTP to the system for producing bioplastic materials from wastewater effluent. The composition of the wastewater effluent solid portion generally included 6.5% oil, 31% cellulose, 10% hemicellulose, 6% lignin, and grit including: 15.1% minerals, 15.5% sand and 15.9% dirt.

Following initial pretreatment removing crude dirt, the wastewater effluent was introduced into a hydrocyclone centrifuge at a pressure of 3 atmospheres for grit removal from the wastewater effluent.

Thereafter, the wastewater effluent was introduced into a collection device formed of a net of a 250 micron mesh. Approximately 50 Kg of solids were collected within the net. The residual liquid portion was discarded.

The solid portion was pressed in a screw press for partial removal of liquids therefrom.

The resultant cellulosic preparation was thereafter dried in a vacuum dryer at a temperature of 40° C. for 12 hours wherein most of the liquids were dried.

The resultant cellulosic preparation composition generally included 13% oil, 60% cellulose, 10% hemicellulose, 6% lignin, and grit including: 5% minerals, 5% sand and 1% dirt.

The dried cellulosic preparation was grinded into powder.

An ABS mixture containing Polylac PA-757 was vacuum dried at a temperature of 80° C. for 12 hours.

The cellulosic preparation powder was introduced into the ABS mixture and hand mixed for forming a mixture containing 15% cellulosic preparation and 85% ABS mixture.

The mixture was extruded in a twin screw extruder (diameter of 25 mm) at 250 rpm.

Thereafter the mixture was vacuum dried for 12 hours at a temperature of 80° C.

60 gram of the dried mixture was subjected to injection molding at a temperature of 33° C., speed of 46 mm/sec and an initial pressure of 160 bar and a secondary pressure of 60 bar. The mixture was injected for 3.24 seconds and cooled for 25 seconds. Resultant specimens (i.e. bioplastic materials) were formed.

### Example 4

100 m³ of wastewater effluent, including a solid portion of approximately 0.1% of the wastewater effluent flowed from a municipal WWTP to the system for producing bioplastic materials from wastewater effluent. The composition of the wastewater effluent solid portion generally included 6.5% oil, 31% cellulose, 10% hemicellulose, 6% lignin, and grit including: 15.1% minerals, 15.5% sand and 15.9% dirt.

Following initial pretreatment removing crude dirt, the wastewater effluent was introduced into a hydrocyclone centrifuge at a pressure of 3 atmospheres for grit removal from the wastewater effluent.

Thereafter, the wastewater effluent was introduced into a collection device formed of a net of a 250 micron mesh. Approximately 50 Kg of solids were collected within the net. The residual liquid portion was discarded.

The solid portion was pressed in a screw press for partial removal of liquids therefrom.

The resultant cellulosic preparation was thereafter dried in a vacuum dryer at a temperature of 40° C. for 12 hours wherein most of the liquids were dried.

The resultant cellulosic preparation composition generally included 13% oil, 60% cellulose, 10% hemicellulose, 6% lignin, and grit including: 5% minerals, 5% sand and 1% dirt.

The dried cellulosic preparation was grinded into powder.

The cellulosic preparation powder was introduced into a PP mixture containing Capilene R-50 and hand mixed for forming a mixture containing 15% cellulosic preparation and 82% PP mixture and 3% of a coupling agent containing BONDYRAM® (functional polymers).

The mixture was extruded in a twin screw extruder (diameter of 25 mm) at 250 rpm.

Thereafter the mixture was vacuum dried for 12 hours at a temperature of 80° C.

65 gram of the dried mixture was subjected to injection molding at a temperature of 33° C., speed of 46 mm/sec and an initial pressure of 100 bar and a secondary pressure of 50 bar. The mixture was injected for 10 seconds and cooled for 25 seconds. Resultant specimens (i.e., bioplastic materials) were formed.

In each of Examples 2-4 the surface of the resultant bioplastic specimens was homogenous indicating the cellulosic preparation properly mixed with the binder material (HDPE in Example 2, ABS in Example 3 and PP in Example 4).

The resultants specimens of Examples 2-4 were subjected to tensile testing and plastic strength tests (ASTM D 638-10 standard) and compared to an unmixed plastic specimen (i.e., 100% HDPE in Example 2, 100% ABS in Example 3 and 100% PP in Example 4).

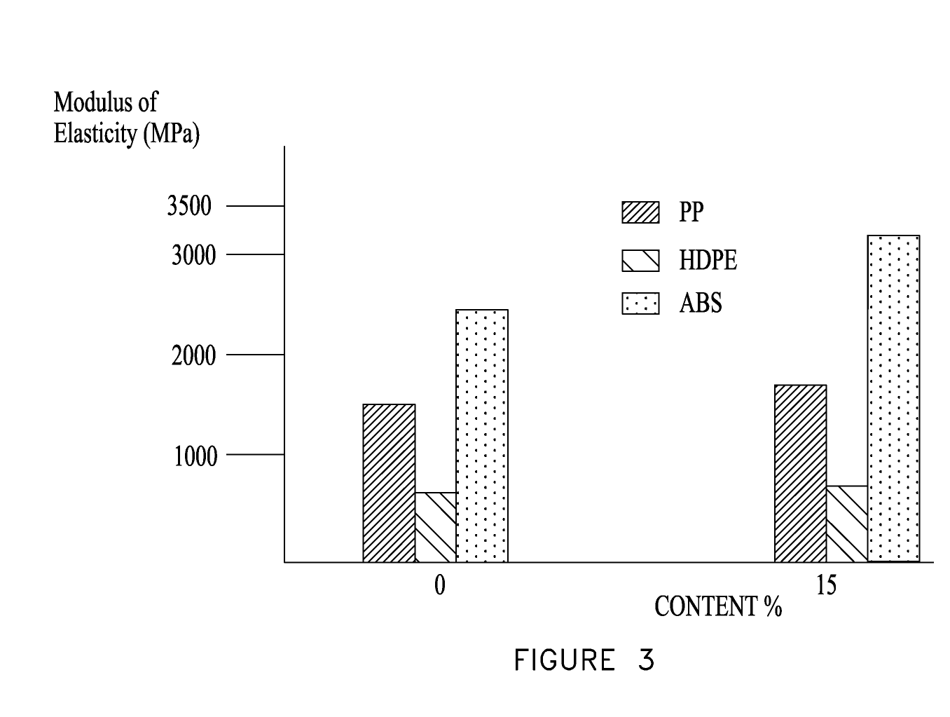

The results indicate in Table 1 for all resultants specimens, a significant drop in the maximal stress load and strain at breaking in comparison with the unmixed plastic specimens. Accordingly, the Modulus of Elasticity per resultant specimens grow in comparison with the unmixed plastic specimens. FIG. 3 is a graph showing the Modulus of Elasticity shown in Table 1.

TABLE 1

| | Content (% | | | |
|---|---|---|---|---|
| | of total | Stress at | Strain at | Modulus of |
| | plastic | Max load | break | Elasticity |
| Polymer | material) | (MPa) | (%) | (MPa) |
| HDPE | 0 | 24.8 | 38.5 | 636.7 |
| | 15 | 20.9 | 25.6 | 789.1 |
| ABS | 0 | 53.1 | 5.6 | 2775.4 |
| | 15 | 36.5 | 3.7 | 3425.0 |
| PP | 0 | 34.4 | 364.8 | 1509.6 |
| | 15 | 28.8 | 6.7 | 1752.5 |

The resultant specimens of Examples 2-4 were subjected to bend testing and flexural properties (ASTM D 790 standard) and compared to an unmixed plastic specimen (i.e., 100% HDPE in Example 2, 100% ABS in Example 3 and 100% PP in Example 4).

The results indicate in Table 2 for all resultant specimens a significant drop in the maximal stress load in comparison with the unmixed plastic specimens. Accordingly, the Modulus of Elasticity per resultant specimens grow in comparison with the unmixed plastic specimens.

TABLE 2

| | Content (% | | |
|---|---|---|---|
| | of total | Stress at | Modulus of |
| | plastic | Max load | Elasticity |
| Polymer | material) | (MPa) | (MPa) |
| ABS | 0 | 89.7 | 3001.7 |
| | 15 | 71.1 | 3280.8 |
| HDPE | 0 | 22.9 | 794.8 |
| | 15 | 23.5 | 921.9 |
| PP | 0 | 48.9 | 1433 |
| | 15 | 47.9 | 1708.8 |

The resultant specimen of Example 4 (15% cellulosic preparation filler mixed with 82% PP mixture and 3% of a coupling agent containing Bondyram® (functional polymers)) was subjected to thermal testing (ASTM D648 standard) at a load of 18.5 kg/cm² and compared to an unmixed plastic PP specimen. The bioplastic material (i.e., the resultant specimen) was found with a 15% increase of a Heat Deflection Temperature (“HDT”) compared to the HDT of the unmixed plastic PP specimen.

The HDT is the temperature at which a polymer or plastic sample deforms under a specified load.

Thus it can be seen that the addition of the cellulosic preparation 180 as a filler to the additional plastics 194 significantly increases the modulus of elasticity indicating an increase in the stiffness of the resultant bioplastic material 188 and thus significantly improves the properties of the resultant bioplastic material 188.

The bioplastic material 188 can be formed to be used as a plastic article in any suitable configuration. Some non-limiting examples are: rods, tubes, pipes, sheets, films wraps, fibers, containers and/or boards. The bioplastic materials 188 can be used in many industries, such as in plumbing, furniture, bottling, packaging and/or electronic packaging, for example.

The bioplastic material 188 produced according to the systems and methods of the disclosure provides for a plurality of superior benefits. The cellulosic preparation 180 has a high cellulosic content. Furthermore, the cellulosic preparation 180, according to some embodiments, can be produced from the wastewater effluent 102 by mechanical processes only, such as collection by collection device 122 and/or by drying in drying device 140. Thus, in some embodiments, the cellulosic preparation 180 can be produced without chemical treatments and/or biological treatments. A chemical treatment includes treatment with chemicals. A biological treatment includes treatment with microorganism, microbes and the like and/or a combination thereof. The cellulosic preparation 180, produced by mechanical processes is intrinsically different than chemically or biologically produced preparations, since the properties of the solid portion from the wastewater effluent remain intact. For example, in a chemical process including hydrolysis, the fibers of the solid portion of the wastewater effluent are broken down, thereby transforming the cellulose into glucose and thus altering the properties of the preparation. In a biological process including anaerobic digestion, the cellulose is digested by the microorganism, thereby reducing the cellulosic content of the preparation.

Moreover, the cellulosic preparation 180 produced by mechanical processes can remain an organic material, while chemically or biologically processing the wastewater can transforms the organic solids (e.g., cellulose) into inorganic materials. In a non-limiting example the cellulosic preparation 180 includes a portion if at least 60% organic materials. In a non-limiting example, the cellulosic preparation 180 can include a portion if at least 70% organic materials. In a non-limiting example, the cellulosic preparation 180 includes a portion if at least 80% organic materials. In a non-limiting example, the cellulosic preparation 180 includes a portion if at least 90% organic materials.

The bioplastic material 188, formed fully or partially of the cellulosic preparation 180, or as a plasticizer or as a filler as shown in and discussed in connection with FIGS. 1 and 2, can be produced by the cellulosic preparation 180 with a high cellulosic content and organic content. Accordingly, the bioplastic material 188 can be biodegradable, compostable and/or recyclable. Additionally, the bioplastic material 188 is non-toxic, due to its high cellulosic content and/or organic content.

In many conventional plasticizers and/or fillers there are concerns due to the toxic and/or environmentally hazardous components thereof. Use of the cellulosic preparation 180 as a plasticizer or filler provides for non-toxic, biodegradable, compostable, recyclable and/or safe plasticizers and/or fillers.

Moreover, the cellulosic preparation produced by mechanical processes of the system 100 can provide for production of the plastic material 188 with substantially decreased carbon or carbon-equivalent emissions.

An additional benefit to producing the cellulosic preparation 180 by mechanical processes can include elimination of use of ecologically harmful chemicals during production thereof in the system 100, thus the method and system of the present subject matter is more environmentally friendly then plastic materials produced by use of chemicals.

In some embodiments, some chemicals can be used to produce the bioplastic material 188, yet to a lesser degree than during production of petrochemical plastics or plastics formed of vegetative biomass from vegetative sources, since during production of the cellulosic preparation 180 little or no chemical are used.

Furthermore, standard treatment of wastewater effluent includes biological treatments. The biological treatment includes digestion of the wastewater effluent by bacteria, which emit carbon dioxide and/or other hazardous gases during digestion. In accordance with the system and method of the disclosure, the wastewater effluent is treated in system 100. Hence, treating the wastewater effluent 102 by mechanical processes eliminates emission of hazardous gases. In some embodiments, the carbon dioxide emitted during treating the wastewater effluent 102 according to some embodiments of the current subject matter, is reduced significantly since most of the organic materials of the solid portion remain organic.

Another benefit is that the relatively high cellulose content allows for production of high quality plastic materials 188.

Furthermore, the cellulosic preparation 180 can include a hydrophilic polar material and therefore mixes well with other polar polymers, thereby producing superior plastic materials 180.

An additional benefit can be that fibers of the cellulosic preparation 180 produced by the systems and methods of the present subject matter have a larger total surface area than fibers retrieved from other sources, such as vegetative sources. The larger total surface area of fibers within the cellulosic preparation 180 results from the disintegration of the fibers within the wastewater as well as the cleaving and/or stirring of fibers the system 100. A relatively large fiber surface area increases contact with additional materials, such as the additional plastics 194, thereby yielding a homogeneous, well-combined plastic material 188.

Another benefit is that the cellulosic preparation 180 is produced from the wastewater effluent of a WWTP. The wastewater effluent is a significantly low cost resource for plastic materials. Additionally the wastewater effluent is a continuously, abundantly available resource due to the high volumes of wastewater effluent flowing daily through WWTPs, thereby increasing the ability to supply growing demands of plastic materials.

Furthermore, the system 100 discloses a controlled drying process within the drying device 140. In some embodiments, the predetermined dryness degree is a significant parameter in efficient plastic processing, wherein at times a very high dryness degree, of over 98% or even 99% is required. The controlled drying of system 100 enables obtaining the predetermined dryness degree of the cellulosic preparation 180 for efficient plastic processing thereof.

Furthermore, the system 100 discloses a controlled grinding process within the drying device 140. In some embodiments, the size of a preparation used to produce plastic materials is a significant parameter in efficient plastic processing. The controlled grinding of system 100 enables obtaining the predetermined size of the cellulosic preparation 180 for efficient plastic processing thereof.

Another benefit is that the cellulosic preparation 180 can have relatively less lignin when compared with solids retrieved from vegetative sources, such as, wood, wheat and corn. In a non-limiting example, cellulosic feedstock produced by the systems and methods of the disclosure contains 30%-60% less lignin than solids retrieved from corn. Use of the cellulosic preparation 180 with a decreased lignin content for producing the plastic materials 188 provides for higher quality plastic materials 188 and combines with additional plastics 194 with greater homogeneity than combination with other solids retrieved from vegetative sources.

Fillers are particles added to materials, such as the additional plastic 194, or other materials. Use of the cellulosic preparation 180 as a filler lowers the consumption of more expensive binder material and improves some properties of the mixed filler and additional plastic 194. The cellulosic preparation 180 combined and mixes well with the additional plastics 194 and also with other materials, such as clays and/or concrete. The addition of the fillers, in some embodiments, improved the mechanical priorities of the plastic materials 188, such as by increasing the stiffness of the plastic materials 188, reinforcing and strengthening the plastic materials 188.

Moreover, in some embodiments, use of the cellulosic preparation 180 as a filler raised the HDT thereby producing a bioplastic material 188 more durable to heat. An additional significant advantage is that the bioplastic material 188 is durable to further plastic processing and subjection to high temperatures. This enables use of the bioplastic material 188 in processes that require relatively high temperatures.

It is noted that the dryness degree can be measured as the relative humidity (RH). The RH measures the humidity of the preparation, which is the difference between 100% and the dryness degree. For example, wherein the measured dryness degree is 98%, the RH is 2%.

FIG. 4 is a schematic illustration of an exemplary system 200 for producing nanocellulose from the wastewater effluent 102. FIG. 5 is a schematic illustration of an exemplary system 204 for producing nanocellulose from the wastewater effluent 102.

The system 200 for producing nanocellulose materials from wastewater effluent can include at least some of the following devices: the pretreatment device 114, the grit removal device 118, the solid collection device 122, the drying device 140, the refining device 212 and a degradation device 220.

The system 204 for producing nanocellulose materials from wastewater effluent can include at least one of the following devices: the pretreatment device 114, the refining device 234, the solid collection device 122, the drying device 140, and the degradation device 220.

Initially, the wastewater effluent 102 (which can include raw sewage or treated sewage prior to digestion thereof) can be introduced into the pretreatment device 114 for removing crude, large, insoluble dirt, such as large rocks, plastic chunks, for example.

The system 200 can include the grit removal device 118 for removing grit from the wastewater.

The now grit-removed, cleaned wastewater can flow to the solid collection device 122 for collecting the solid portion 124 from the cleaned wastewater effluent 102 and thus substantially separating the solid portion from the liquid portion 130. The residual, liquid portion 130 can be discharged from solid collection device 122 via the outlet 136 or any suitable means.

In some embodiments, the collected solid portion 124 can be dried to a predetermined dryness degree thereof.

The drying can be performed by the drying device 140 configured to achieve the predetermined humidity level of the collected solid portion 124.

In some embodiments, the collected solid portion 124 can be de-clumped, cleaved or grinded as described in system 100 and in some embodiments, to achieve a predetermined particle size.

The system 200 and/or 204 can include the controller 191 configured to control various parameters of the operation of the system 200, such as the temperature used by the drying device 140 to reach the predetermined dryness degree of the collected solid portion 124 and/or the grinding degree used to reach the predetermined particle size of the collected solid portion 124.

The collected solid portion dried to the predetermined dryness degree includes the cellulosic preparation 180. The cellulosic preparation 180 can be further refined so as to remove non-cellulosic content from the cellulosic preparation 180 to produce a high-cellulosic preparation 210. The removal of the non-cellulosic content can be performed in any suitable manner, such as in a refining device 212.

In a non-limiting example the removal of the non-cellulosic content may be performed by at least one or more of the following methods, such as mechanically, such as by filtering the cellulosic preparation 180 in fine filters, nets or meshes or by sedimentation. The removal of the non-cellulosic content may be performed by use of heat. The removal of the non-cellulosic content may be performed chemically, such as by hydrolysis; additions of acids, such as sulfuric acids; hydrochloric acid; bleaches; carboxymethylation; oxidation; formate-containing compositions including at least one of the group of formic acid, calcium formate, potassium formate, magnesium formate, ammonium formate and/or liquid formats, ethyl formate, methyl formate, butyl format acetic-formic solutions or any mixture thereof; carboxylate-containing compositions including at least one of the group of citric acid, iso-citric acid, fumaric acid, oxalic acid, malic or maleic acids, its derivatives or any mixture thereof. In some embodiments, the removal of the non-cellulosic content can be performed by immersing the cellulosic preparation in a solution including an alkaline solution with a pH level greater than 9 or an acidic solution with a pH level less than 6.

In some embodiments, additional means for removal of the non-cellulosic content may be included in the system 200 and/or 204, such as by a filtration device, which can include a precipitator, such as an electrostatic precipitator.

In some embodiments, the removal of the non-cellulosic content can be performed prior to drying of the collected solids. For example, as shown in FIG. 5, the non-cellulosic content removal can be performed following the grit removal. In some embodiments, the non-cellulosic content removal can be performed along with the grit removal step by designing the grit removal device as a refining device 234 configured to include additional steps or apparatus for removal of non-cellulosic content from the wastewater effluents. For example, a series of subsequent finer nettings may be provided.

In some embodiments, the high-cellulosic preparation 210 can include a cellulosic content cellulose content of 70-100% of a dry weight thereof. In some embodiments, the high-cellulosic preparation 210 can include a cellulose content of 80-100% of a dry weight thereof. In some embodiments, the high-cellulosic preparation 210 can include a cellulosic content of 90-100% of a dry weight thereof. In some embodiments, the high-cellulosic preparation 210 can include a cellulose content of 95-100% of a dry weight thereof. In some embodiments, the high-cellulosic preparation 210 can include a predetermined cellulose content thereof.

Fibers of the high-cellulosic preparation 210 can undergo degradation by a degradation device 220 configured to produce nanocellulose from the high-cellulosic preparation 210.

In some embodiments, the degradation device 220 can include a delamination device, so as to delaminate the cell walls of the cellulose fibers to yield the nanosized fibrils of the cellulose fibers in the high-cellulosic preparation 210, which nanosized fibrils form the nanocellulose material 230.

In some embodiments, the delamination device can include high-pressure, high temperature and/or high velocity impact homogenization. In some embodiments, the delamination device can include a sonicator to perform the delamination by sonication.

In some embodiments, the nanocellulose material 230, produced by delamination of the high-cellulosic preparation 210, can form a material composed of nanosized cellulose fibrils with a high aspect ratio (length to width ratio). For example, lateral dimensions can be 5-20 nanometers and longitudinal dimension can be from tens of nanometers to several micrometers. In some embodiments, nanocellulose material 230 is formed with a lateral dimension 240 in the range of 1-100 nanometers and a longitudinal dimension 244 can be from 10-9000 nanometers, In some embodiments, nanocellulose material 230 is formed with the lateral dimension 240 in the range of 1-50 nanometers and the longitudinal dimension 244 can be from 10-5000 nanometers. The dimensions of the nanocellulose material 230 are not shown to scale in FIGS. 4 and 5.

In some embodiments, the degradation device 220 can include a hydrolyser configured hydrolyze an amorphous section of the fibers of the high-cellulosic preparation 210, thereby producing a crystalline form of nanocellulose. The hydrolysis can be formed in any suitable manner, such as by an acid solution of acid hydrolysis, which may include sulfuric acid or hydrochloric acid, for example, or any other acid, such as described herein. In some embodiments, the hydrolysis can be formed by immersion in a solution including an alkaline solution with a pH level greater than 9 or an acidic solution with a pH level less than 6. In some embodiments, the hydrolysis can be formed by use of heat in addition to the immersion.

The degradation device 220 can further include means for retrieving the crystallines from the acid solution, such as by centrifugation, washes with water or any suitable liquid and/or sonication.

In some embodiments, the nanocellulose material 230, produced by hydrolysis of the high-cellulosic preparation 210, can form a material including crystalline, also referred to as nanocrystalline cellulose (NCC) or “cellulose nanowhiskers”. In some embodiments, cellulose nanowhiskers can include rodlike, highly crystalline particles with a rectangular cross section. The nanocrystalline cellulose can be formed with longitudinal dimension of 100 s to 1000 nanometers.

In some embodiments, nanocellulose material 230 including the nanocrystalline cellulose is formed with the lateral dimension 240 in the range of 1-100 nanometers and the longitudinal dimension 244 can be in a range of 10-1000 nanometers. In some embodiments, nanocellulose material 230 including the nanocrystalline cellulose is formed with the lateral dimension 240 in the range of 1-100 nanometers and the longitudinal dimension 244 can be from 100-1000 nanometers.

The degradation device can include any suitable device or a plurality of devices and/or processes for producing the nanocellulose material 230 from the high-cellulosic preparation 210 or even from the cellulosic preparation 180.

In some embodiments, the high-cellulosic preparation 210 or the cellulosic preparation 180 can be subjected to any process for producing the nanocellulose material 230 therefrom.

### Example 5

5000 m³ of wastewater effluent, including a solid portion of approximately 0.1% of the wastewater effluent, flowed from a municipal WWTP to the system for producing nanocellulose materials from wastewater effluent. The composition of the wastewater effluent solid portion generally included 6.5% oil, 31% cellulose, 10% hemicellulose, 6% lignin, and grit including: 15.1% minerals, 15.5% sand and 15.9% dirt.

Following initial pretreatment removing crude dirt, the wastewater effluent was introduced into a hydrocyclone centrifuge at a pressure of 3 atmospheres for grit removal from the wastewater effluent.

Thereafter the wastewater effluent was introduced into a collection device formed of a net of a 250 micron mesh.

The resultant cellulosic preparation was thereafter dried in a drying device, such as described in co-owned PCT publication WO2014/057348, to a RH degree of 12%.

The resultant cellulosic preparation composition generally included 8% oil, 55% cellulose, 25% hemicellulose, 0.3% lignin, and grit including: 4% minerals, 2% sand and 5% dirt.

The cellulosic preparation was introduced into a refining device including filtering the cellulosic preparation in a 100 micron mesh. The filtered cellulosic preparation was washed by water for 4 times.

The now high-cellulosic preparation was hydrolyzed by immersion in an acidic solution and heated to a temperature of 70 C.° for an hour. Thereafter continuous water washes were performed (5 times) in a centrifuge, which caused the cellulosic fibers to sediment and the non-cellulosic content was cleaned by the acidic solution. Thereafter sonication was performed in a sonicator for an hour and the nanocellulose material was produced.

The cellulosic preparation was weighed after drying thereof and the resultant nanocellulose material was weighed. It was found that the nanocellulose material weight was 20% of the cellulosic preparation weight, which is considered a very high material yield.

Nanocellulose materials 230 and nanocellulose-including materials can have superior mechanical properties, such as increased strength, tensile strength (for example as high as 500 MPa and high stiffness, as high as 140-220 GPa).

The nanocellulose material 230 produced according to the systems and methods of the present subject matter provides for a plurality of superior benefits.

The fiber degradation (e.g., by delamination or hydrolysis) of cellulose from a vegetative source, such as wood pulp, consumes relatively high energy, for example 30 MWh can be required to delaminate a ton of wood pulp. Fiber degradation of the high-cellulosic preparation 210 can require significantly less energy due to the high-cellulose content of the high-cellulosic preparation 210, which may have been cleaned and also may have been grinded and/or cleaved in the system 200.

As described herein, the cellulosic preparation 180 can contain relatively less lignin when compared with solids retrieved from vegetative sources, such as, wood, wheat and corn. Accordingly in degradation (e.g., delamination or hydrolysis) of the high-cellulosic preparation 210, less energy needs be consumed to degrade the low-lignin containing high-cellulosic preparation 210 than for the high-lignin containing vegetative source. In a non-limiting example, degradation of the high-cellulosic preparation 210 can consume less than 1 MWh per ton or even in the order of 10-900 kWh per ton.

The high-cellulosic preparation 210 has a high cellulosic content. Further, the high-cellulosic preparation 210, according to some embodiments, can be produced without digestion, which employs environmentally hazardous, carbon emitting biological digesters. In a biological process including anaerobic digestion, the cellulose is digested by the microorganism, thereby reducing the cellulosic content of the preparation. Accordingly, the nanocellulose material 230, formed fully or partially of the high-cellulosic preparation 210, as described in FIGS. 4 and 5, is produced by the high-cellulosic preparation 210 with a high cellulosic content and organic content. Accordingly, the nanocellulose material 230 is biodegradable, compostable and recyclable. Additionally, the nanocellulose material 230 is non-toxic, due to its high cellulosic content and organic content.

Producing nanocellulose materials 230 from the high-cellulosic preparation 210 is greatly efficient since it was found that there is high production yield. In a non-limiting example, the mass (i.e. weight) of nanocellulose materials 230 produced from a mass of cellulosic preparation 180 was 20%, namely 200 grams nanocellulose material were produced from a kilo of the cellulosic preparation.

In accordance with some embodiments, the nanocellulose materials 230 can be produced from a fluid source containing cellulose. In a non-limiting example, the fluid source can include a WWTP, including a municipal wastewater system, an agricultural wastewater system or an industrial wastewater system, including pulp and/or paper industry wastewater systems, which include wastewater flowing from paper plants or paper mills.

In some embodiments, pulp and/or paper industry wastewater systems can include processes and/or apparatuses for treatment and/or management of chemical waste produced during the pulp/paper production, such as by designing locations for chemical waste streams. In some embodiments, producing the nanocellulose materials 230 at a pulp and/or paper industry wastewater system, allows use of the already existing chemical waste processes and/or apparatuses for treatment and/or management of chemicals used (e.g. acids used for hydrolysis) to produce the nanocellulose materials 230.

The nanocellulose material 230 can be used to produce a plurality of diverse materials, such as for example biofuels, glass, paper, paperboard, plastics, bioplastics, or even scaffolds for growing replacement organs for transplantation.

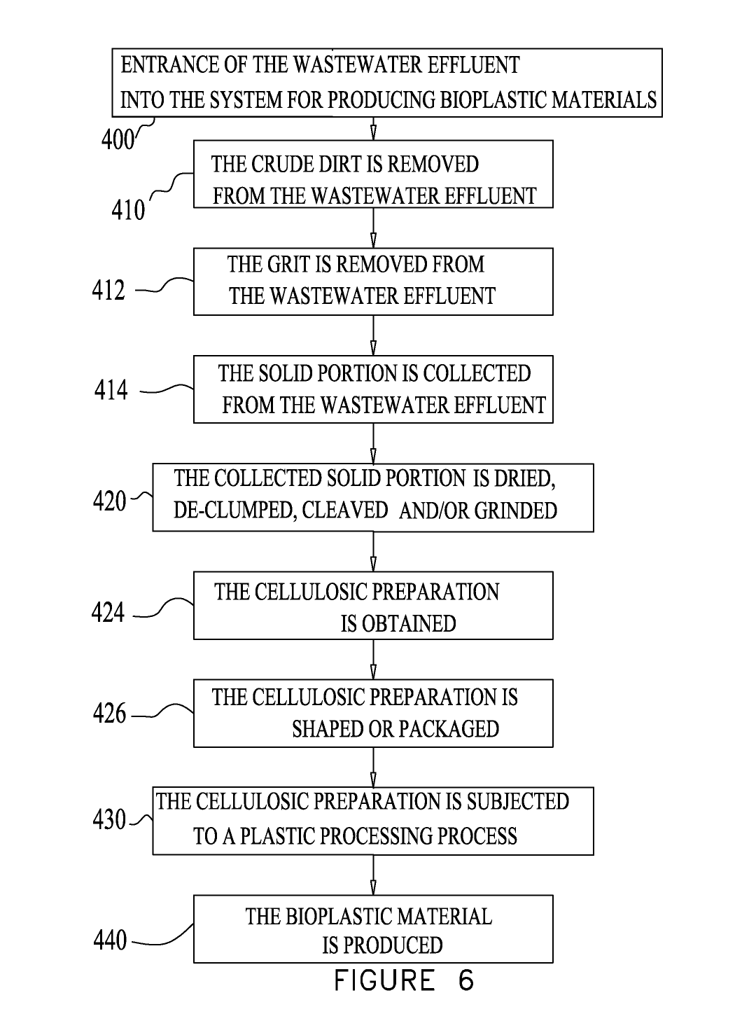

FIG. 6 is an exemplary flowchart of a process for producing bioplastic materials from wastewater effluent. At 400, the wastewater effluent 102 can enter into a system (e.g., such as systems shown in FIGS. 1, 2, 4, and/or 5) for producing bioplastic materials from wastewater effluent. At 410, crude dirt can be removed from the wastewater effluent 102 in any suitable manner. Thereafter, grit can be removed from the wastewater effluent 102 in any suitable manner, at 412. At 414, the solid portion can be collected from the wastewater effluent 102. At 420, the collected solid portion can be dried, de-clumped, cleaved and/or grinded to obtain the cellulosic preparation 180, at 424. In some embodiments, the cellulosic preparation 180 can be shaped or packaged in any suitable manner, at 426. At 430, the cellulosic preparation 180 can be subjected to a plastic processing process. The plastic processing process can include any suitable process to produce the bioplastic material 188, at 440.

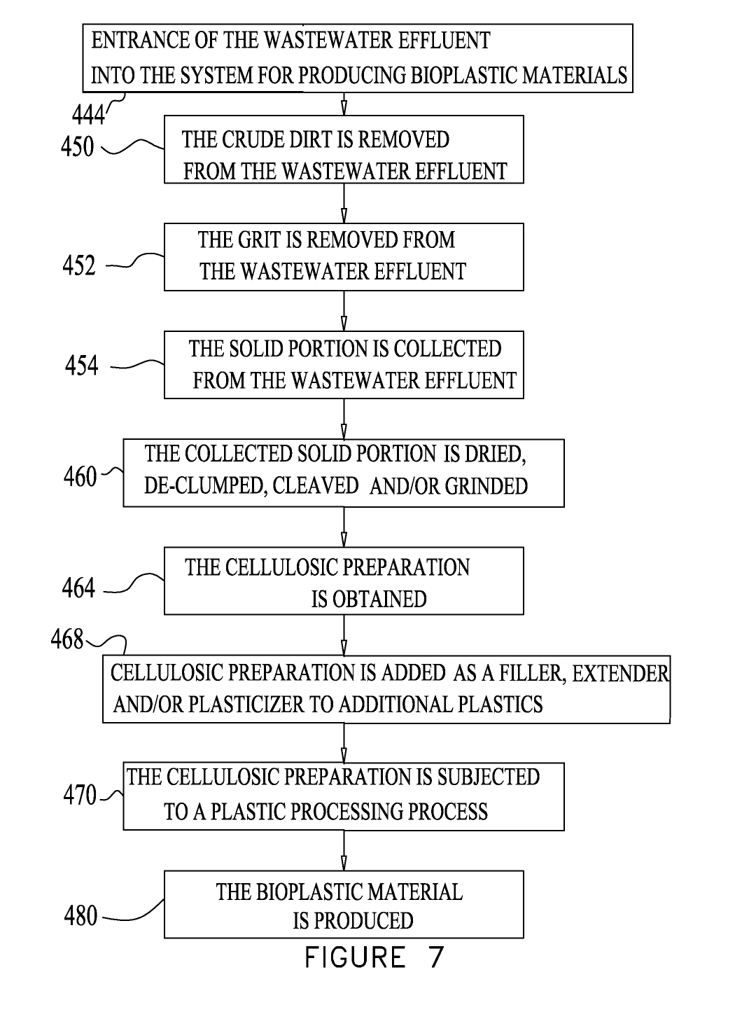

FIG. 7 is an exemplary flowchart of a process for producing bioplastic materials from wastewater effluent. At 444, the wastewater effluent 102 can enter into the system (e.g., such as systems shown in FIGS. 1, 2, 4, and/or 5) for producing bioplastic materials from wastewater effluent. At 450, crude dirt can be removed from the wastewater effluent 102 in any suitable manner. Thereafter, grit can be removed from the wastewater effluent 102 in any suitable manner, at 452. At 454, the solid portion can be collected from the wastewater effluent 102. At 460, the collected solid portion can be dried, de-clumped, cleaved and/or grinded to obtain the cellulosic preparation 180, at 464. At 468, cellulosic preparation 180 can be added as a filler, extender and/or plasticizer to additional plastics 194. At 470, the cellulosic preparation 180 and additional plastics 194 can be subjected to a plastic processing process. The plastic processing process can include any suitable process to form the bioplastic material 188, at 480.

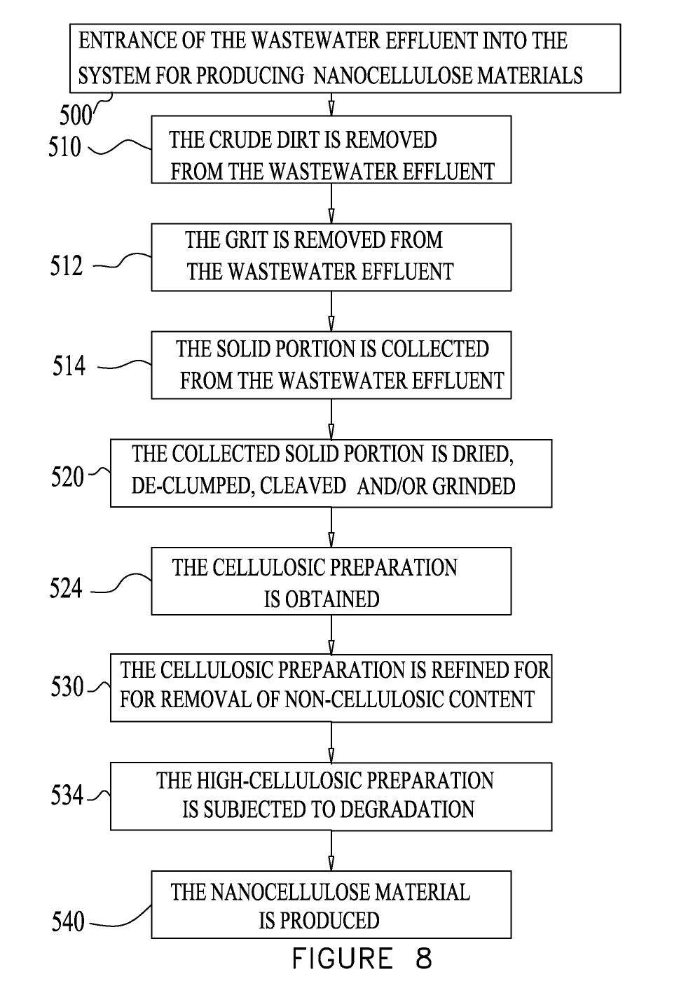

FIG. 8 is an exemplary flowchart of a process for producing nanocellulosic materials from wastewater effluent. At 500, the wastewater effluent 102 can enter into the system (e.g., such as systems shown in FIGS. 1, 2, 4, and/or 5) for producing bioplastic materials from wastewater effluent. At 510, crude dirt can be removed from the wastewater effluent 102 in any suitable manner. Thereafter, grit can be removed from the wastewater effluent 102 in any suitable manner, at 512. At 514, the solid portion can be collected from the wastewater effluent 102. At 520, the collected solid portion can be dried, de-clumped, cleaved and/or grinded to obtain the cellulosic preparation 180, at 524. At 530, the cellulosic preparation 180 can be refined for removal of at least a portion of non-cellulosic content therefrom. At 534, the resultant high-cellulosic preparation 210 can be subjected to degradation by the degradation device 220 configured to produce the nanocellulose material 230, at 540.

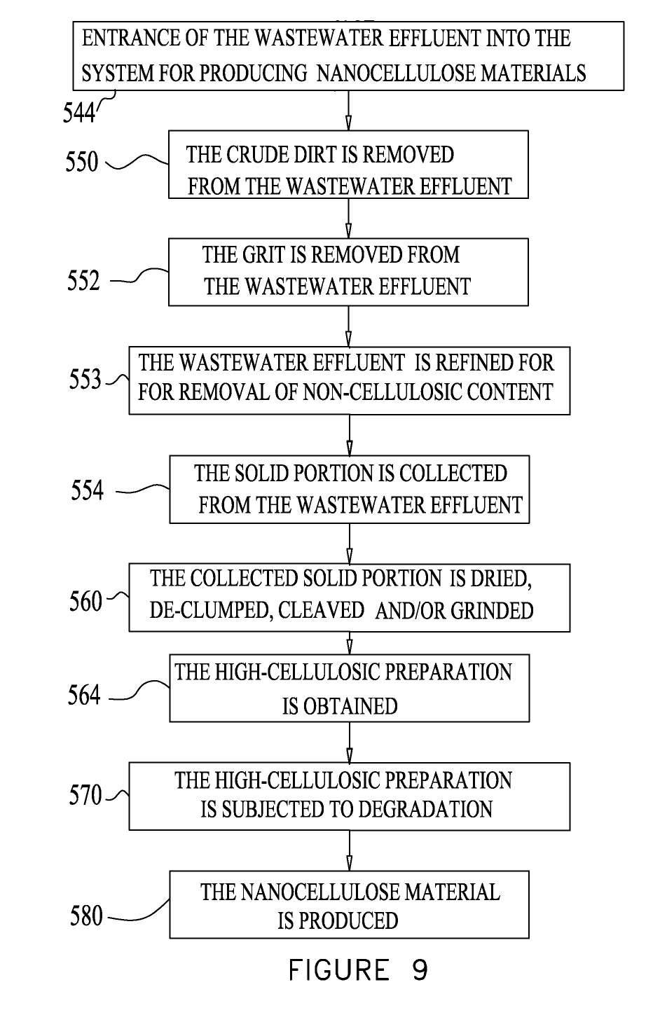

FIG. 9 is an exemplary flowchart of a process for producing nanocellulosic materials from wastewater effluent. At 544, the wastewater effluent 102 can enter into the system (e.g., such as systems shown in FIGS. 1, 2, 4, and/or 5) for producing nanocellulosic materials from wastewater effluent. At 550, crude dirt can be removed from the wastewater effluent 102 in any suitable manner. Thereafter, grit can be removed from the wastewater effluent 102 in any suitable manner, at 552. At 553, the wastewater effluent 102 can be refined for removal of at least a portion of non-cellulosic content therefrom. In some embodiments, the grit removal and refining can be combined together or performed consecutively. At 554, the solid portion can be collected from the wastewater effluent 102. At 560, the collected solid portion can be dried, de-clumped, cleaved and/or grinded to obtain the high-cellulosic preparation 210, at 564. At 570, the high-cellulosic preparation 210 can be subjected to degradation by the degradation device 220 configured to produce the nanocellulose material 230, at 580.

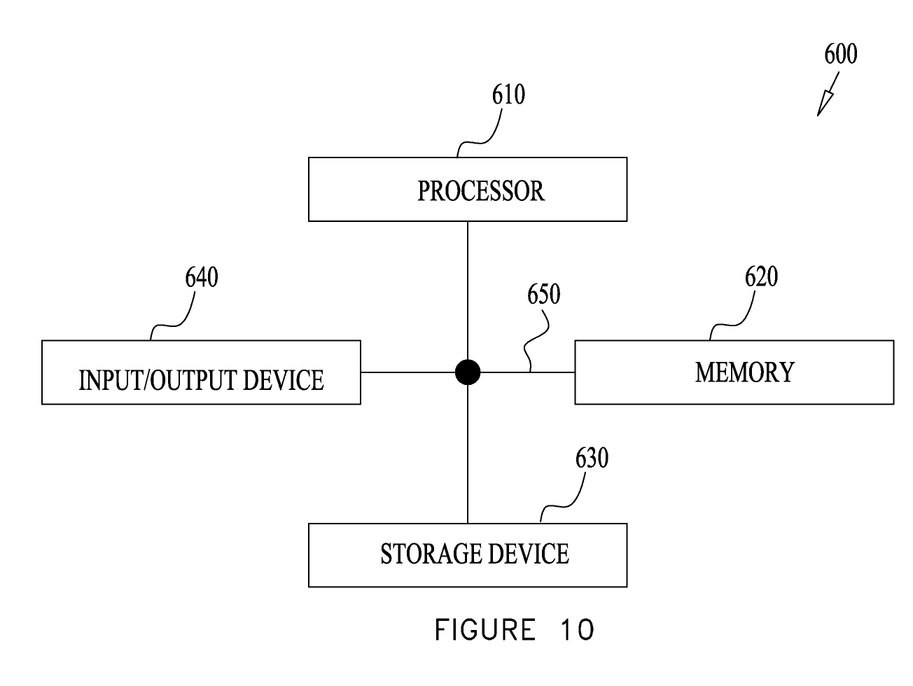

In some embodiments, the current subject matter can implement a computer-implemented system, a computer-implemented method, and/or a computer program product for the purposes of controlling various operations performed by one or more components of the system ((e.g., such as systems shown in FIGS. 1, 2, 4, and/or 5) and/or the entire system. Such exemplary computer-implemented system is illustrated in FIG. 10 as system 600. The system 600 can include a processor 610, a memory 620, a storage device 630, and an input/output device 640. Each of the components 610, 620, 630 and 640 can be interconnected using a system bus 650. The processor 610 can be configured to process instructions for execution within the system 600. In some implementations, the processor 610 can be a single-threaded processor. In alternate implementations, the processor 610 can be a multi-threaded processor. The processor 610 can be further configured to process instructions stored in the memory 620 or on the storage device 630, including receiving or sending information through the input/output device 640. The memory 620 can store information within the system 600. In some implementations, the memory 620 can be a computer-readable medium. In alternate implementations, the memory 620 can be a volatile memory unit. In yet some implementations, the memory 620 can be a non-volatile memory unit. The storage device 630 can be capable of providing mass storage for the system 600. In some embodiments, the storage device 630 can be a computer-readable medium. In alternate embodiments, the storage device 630 can be a floppy disk device, a hard disk device, an optical disk device, a tape device, non-volatile solid state memory, or any other type of storage device. The input/output device 640 can be configured to provide input/output operations for the system 600. In some embodiments, the input/output device 640 can include a keyboard and/or pointing device. In alternate embodiments, the input/output device 640 can include a display unit for displaying graphical user interfaces.

In some embodiments, the system 600 can operate in conjunction with the controller 191 (e.g., as shown in FIGS. 1, 2, 4, and 5). The controller 191 can be configured to receive and/or process various signals relating to the operation of the systems discussed above. The signals can be transmitted to the controller from various sensors that can be disposed in the systems discussed above. In some embodiments, one or more components in the system (such as systems shown in FIGS. 1, 2, 4, and/or 5) can include one or more sensors. The sensors can be used to detect and/or determine at least one of the following: presence/absence of effluent, malfunctions of one or more components, operational status of one or more components (e.g., on/off, operating speed, temperature, relative humidity, dryness level, pH level, etc.), as well as any other parameters relating to the operation and/or status of one or more components and/or the system overall. The sensor(s) can be configured to generate a signal and transmit same to the controller 191 via a wireless, wired, and/or any other connection (e.g., the Internet, intranet, WAN, LAN, MAN, Wi-Fi, etc.). The controller 191 can be configured to process the received signal(s) and generate appropriate instructions to one or more components in the system (e.g., on/off, increase/decrease heating temperature, increase/decrease speed of processing of effluent, etc.). The received signals can also serve as triggers that can cause the controller 191 to perform various functions. The sensors can be any conventionally known sensors that are designed to perform specific functions (e.g., measure temperature, measure dryness level, detect speed, detect presence of effluent, etc.).

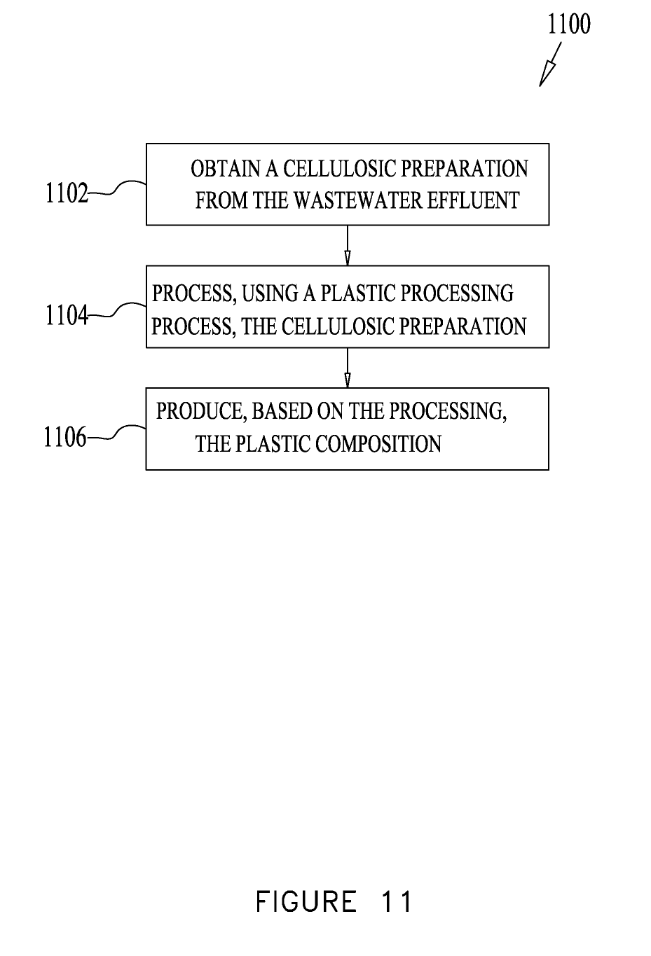

FIG. 11 illustrates an exemplary process 1100 for producing a plastic composition from a wastewater effluent, according to some embodiments of the current subject matter. At 1102, a cellulosic preparation can be obtained from the wastewater effluent. The cellulosic preparation can include a predetermined dry weight content of cellulose. At 1104, using a plastic processing process, the cellulosic preparation can be processed. At 1106, based on the processing, the plastic composition can be produced.

In some embodiments, the current subject matter can include one or more of the following optional features. The obtaining can include removing grit from the wastewater effluent, obtaining at least one solid material from the wastewater effluent, and drying the obtained at least one solid material.

In some embodiments, the predetermined dry weight content of cellulose can include at least 40% weight content of cellulose. In some embodiments, the predetermined dry weight content of cellulose can include at least 60% weight content of cellulose.

In some embodiments, the plastic processing process can include at least one of the following: an extrusion molding, an injection molding, and a blow molding. In some embodiments, the processing can include mixing the cellulosic preparation with at least one additional plastic material. In some embodiments, the cellulosic preparation can include a filler. The additional plastic material can include at least one of the following: polyethylene, polypropylene and acrylonitrile butadiene styrene, polyvinyl chloride, polycarbonate and a thermoplastic and a combination thereof. The filler can be 1-50% of total dry weight of the plastic composition. In some embodiments, the cellulosic preparation can include a plasticizer. The plasticizer can be 1-10% of total dry weight of the plastic composition. In some embodiments, the additional plastic material can include a petrochemical containing plastic.

In some embodiments, the cellulosic preparation can include a dry weight content of lignin in a range of 0-15%. In some embodiments, the cellulosic preparation can include a dry weight content of oil in a range of 0-30%.

In some embodiments, the cellulosic preparation is not produced by biological processes. In some embodiments, the cellulosic preparation is not produced by chemical processes.

In some embodiments, the wastewater effluent can be obtained from at least one of the following: a wastewater treatment plant, a municipal sewage wastewater system, an agricultural wastewater system, an industrial wastewater system, a pulp and/or paper industry wastewater system, a paper plant and a paper mill.

In some embodiments, the obtaining can include controlling the cellulosic preparation to be produced with a predetermined dryness degree and/or a predetermined particle size. In some embodiments, the method can include measuring the predetermined dryness degree using at least one sensor. In some embodiments, the method can include measuring the predetermined particle size using at least one sensor.

In some embodiments, the cellulosic preparation can be characterized by a predetermined dryness degree. The predetermined dryness degree can be in the range of 70%-99.99%. The cellulosic preparation can be characterized by a predetermined particle size.

In some embodiments, the predetermined particle size of the cellulosic preparation can be in the range of 0.01 μm-500 mm.

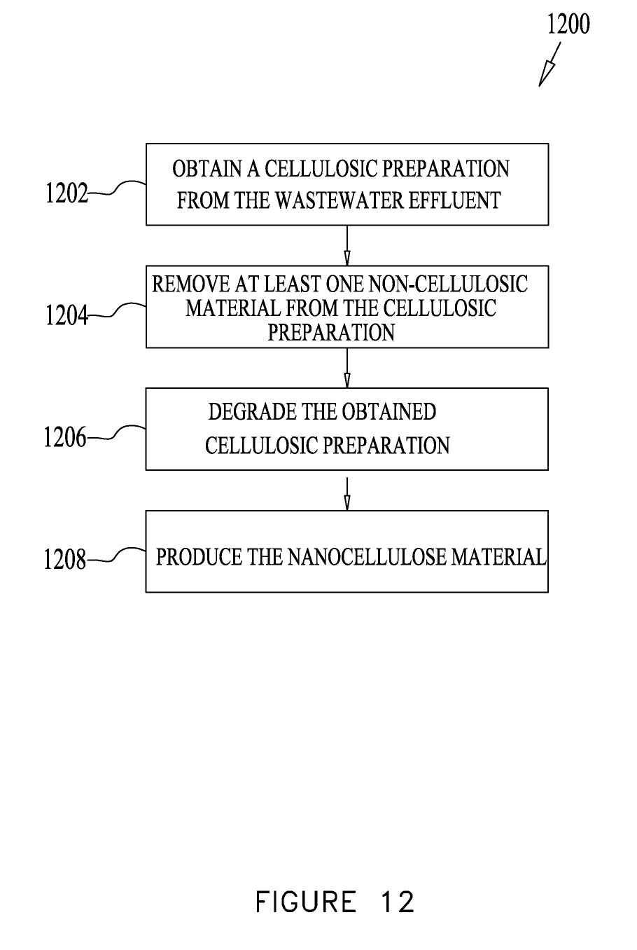

FIG. 12 illustrates an exemplary process 1200 for producing a nanocellulose material from a wastewater effluent, according to some embodiments of the current subject matter. At 1202, a cellulosic preparation can be obtained from the wastewater effluent. The cellulosic preparation can include a predetermined dry weight content of cellulose. At 1204, at least one non-cellulosic material can be removed from the wastewater effluent or from the cellulosic preparation. At 1206, the obtained cellulosic preparation can be degraded. At 1208, the nanocellulose material can be produced.

In some embodiments, the wastewater effluent can include at least one of the following: a wastewater from a pulp and a wastewater from a paper mill.

In some embodiments, the obtaining can include removing grit from the wastewater effluent and obtaining at least one solid material from the wastewater effluent.

In some embodiments, the predetermined dry weight content of cellulose can include at least 70% weight content of cellulose.

In some embodiments, the degrading can be performed by a delamination device. The delamination device can include at least one of the following: homogenization device, a high-pressure impact homogenization device, a high temperature impact homogenization device, a high velocity impact homogenization device, and a sonication device. In some embodiments, the degrading can be performed by hydrolysis. In some embodiments, the degrading can be performed by acid hydrolysis. The acid hydrolysis can be performed with a sulfuric acid, or hydrochloric acid and/or a combination thereof.

In some embodiments, the wastewater effluent can flow from any one of: a wastewater treatment plant, a municipal sewage wastewater system, an agricultural wastewater system, an industrial wastewater system, a pulp and/or paper industry wastewater system, a paper plant and/or a paper mill.

In some embodiments, the nanocellulose material can include a nanofibrillated cellulose material. In some embodiments, the nanocellulose material can include a nanocrystalline cellulose material. In some embodiments, the cellulosic preparation can be characterized by a predetermined dryness degree. The predetermined dryness degree is in a range of 70%-99.99%. In some embodiments, the cellulosic preparation can be characterized by a predetermined particle size. The predetermined particle size of the cellulosic preparation can be in a range of 0.01 μm-500 mm.

In some embodiments, the nanocellulose material can be formed with a lateral dimension 240 in the range of 1-100 nanometers and a longitudinal 244 dimension in the range of 10-9000 nanometers. In some embodiments, the nanocrystalline cellulose material can be formed with a lateral dimension 240 in the range of 1-100 nanometers and a longitudinal dimension 244 in the range of 100-1000 nanometers

The systems and methods disclosed further implement, for example, a data processor, such as a computer that also includes a database, digital electronic circuitry, firmware, software, or in combinations of them. Moreover, the above-noted features and other aspects and principles of the present disclosed implementations can be implemented in various environments. Such environments and related applications can be specially constructed for performing the various processes and operations according to the disclosed implementations or they can include a general-purpose computer or computing platform selectively activated or reconfigured by code to provide the necessary functionality. The processes disclosed herein are not inherently related to any particular computer, network, architecture, environment, or other apparatus, and can be implemented by a suitable combination of hardware, software, and/or firmware. For example, various general-purpose machines can be used with programs written in accordance with teachings of the disclosed implementations, or it can be more convenient to construct a specialized apparatus or system to perform the required methods and techniques.

The systems and methods disclosed herein can be implemented using a computer program product, i.e., a computer program tangibly embodied in an information carrier, e.g., in a machine readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

As used herein, the term “user” can refer to any entity including a person or a computer.

Although ordinal numbers such as first, second, and the like can, in some situations, relate to an order; as used in this document ordinal numbers do not necessarily imply an order. For example, ordinal numbers can be merely used to distinguish one item from another. For example, to distinguish a first event from a second event, but need not imply any chronological ordering or a fixed reference system (such that a first event in one paragraph of the description can be different from a first event in another paragraph of the description).

The foregoing description is intended to illustrate but not to limit the scope of the invention, which is defined by the scope of the appended claims. Other implementations are within the scope of the following claims.

These computer programs, which can also be referred to programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, the subject matter described herein can be implemented on a computer having a display device, such as for example a cathode ray tube (CRT) or a liquid crystal display (LCD) monitor for displaying information to the user and a keyboard and a pointing device, such as for example a mouse or a trackball, by which the user can provide input to the computer. Other kinds of devices can be used to provide for interaction with a user as well. For example, feedback provided to the user can be any form of sensory feedback, such as for example visual feedback, auditory feedback, or tactile feedback; and input from the user can be received in any form, including, but not limited to, acoustic, speech, or tactile input.

The subject matter described herein can be implemented using a computing system that includes a back-end component, such as for example one or more data servers, or that includes a middleware component, such as for example one or more application servers, or that includes a front-end component, such as for example one or more client computers having a graphical user interface or a Web browser through which a user can interact with an implementation of the subject matter described herein, or any combination of such back-end, middleware, or front-end components. The components of the system can be interconnected by any form or medium of digital data communication, such as for example a communication network. Examples of communication networks include, but are not limited to, a local area network (“LAN”), a wide area network (“WAN”), and the Internet.

The computing system can include clients and servers. A client and server are generally, but not exclusively, remote from each other and typically interact through a communication network. The relationship of client and server arises by virtue of computer programs running on the respective computers and having a client-server relationship to each other.

The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and sub-combinations of the disclosed features and/or combinations and sub-combinations of several further features disclosed above. In addition, the logic flows depicted in the accompanying figures and/or described herein do not necessarily require the particular order shown, or sequential order, to achieve desirable results. Other implementations can be within the scope of the following claims.

1-61. (canceled)

62. A method for producing a plastic composition from a wastewater effluent, comprising:
obtaining a cellulosic preparation from the wastewater effluent, wherein the cellulosic preparation includes a predetermined dry weight content of cellulose;
processing, using a plastic processing process, the cellulosic preparation; and
producing, based on the processing, the plastic composition.

63. The method according to claim 62 wherein the cellulosic preparation comprises a filler and wherein the filler is 1-50% of total dry weight of the plastic composition.

64. The method according to claim 62, wherein the processing comprises mixing the cellulosic preparation with at least one additional plastic material.

65. The method according to claim 62, wherein the processing comprises mixing the cellulosic preparation with at least one additional plastic material, the additional plastic material comprises at least one of the following: polyethylene, polypropylene, acrylonitrile butadiene styrene, polyvinyl chloride, polycarbonate and a thermoplastic and a combination thereof.

66. The method according to claim 62, wherein the cellulosic preparation comprises at least one of: a dry weight content of lignin in a range of 0-15%; and a dry weight content of oil in a range of 0-30%.

67. The method according to claim 62, wherein the cellulosic preparation is not produced by biological processes.

68. The method according to claim 62, wherein the cellulosic preparation is not produced by chemical processes.

69. The method according to claim 62, wherein the wastewater effluent is obtained from at least one of the following: a wastewater treatment plant, a municipal sewage wastewater system, an agricultural wastewater system, an industrial wastewater system, a pulp and/or paper industry wastewater system, a paper plant and a paper mill.

70. The method according to claim 62, wherein the cellulosic preparation is characterized by a predetermined dryness degree in the range of 70%-99.99%.

71. The plastic composition according to claim 62, wherein the predetermined dry weight content of cellulose is greater than or equal to 40%.

72. The method according to claim 62, wherein the cellulosic preparation is characterized by a predetermined particle size in the range of 0.01 mm-500 mm.

73. A method for producing a nanocellulose composition from a wastewater effluent, comprising:
obtaining a cellulosic preparation from the wastewater effluent, wherein the cellulosic preparation includes a predetermined dry weight content of cellulose;
removing at least one non-cellulosic material from the cellulosic preparation;
degrading the obtained cellulosic preparation; and
producing the nanocellulose composition.

74. The method according to claim 73, wherein the predetermined dry weight content of cellulose includes at least 70% weight content of cellulose.

75. The method according to claim 73, wherein the degrading is performed by a delamination device, wherein the delamination device includes at least one of the following: a high-pressure impact homogenization device, a high temperature impact homogenization device, a high velocity impact homogenization device, and a sonication device.

76. The method according to claim 73, wherein the wastewater effluent is from any one of: a wastewater treatment plant, a municipal sewage wastewater system, an agricultural wastewater system, an industrial wastewater system, a pulp and/or paper industry wastewater system, a paper plant and a paper mill.

77. The nanocellulose composition according to claim 73, wherein the nanocellulose includes at least one of the following: a microfibrillated cellulose (MFC), a nanofibrillated cellulose (NFC), and a nanocrystalline cellulose (NCC).

78. The method according to claim 73, wherein the cellulosic preparation is characterized by a predetermined particle size in a range of 0.01 mm-500 mm.

79. The method according to claim 73, wherein the nanocellulose composition is characterized with a lateral dimension in the range of 1-100 nanometers and a longitudinal dimension in the range of 10-9000 nanometers.

80. A nanocellulose composition made according to the method of claim 73.

81. The nanocellulose composition according to claim 80, wherein the nanocellulose includes at least one of the following: a microfibrillated cellulose (MFC), a nanofibrillated cellulose (NFC), and a nanocrystalline cellulose (NCC).
